(19) United States
(12) Patent Application Publication
(10) Pub. No.: US 2025/0131178 A1
(43) Pub. Date: Apr. 24, 2025

(54) Method for Optimizing Placement Process of Surface Mounters Based on Heuristic Adaptive Tabu Search

(71) Applicant: Harbin Institute of Technology, Harbin City (CN)

(72) Inventors: Huijun GAO, Harbin (CN); Zhengkai LI, Harbin (CN); Junhu CAO, Harbin (CN); Xinghu YU, Harbin (CN); Hao SUN, Harbin (CN); Jianbin QIU, Harbin (CN); Weichao SUN, Harbin (CN)

(21) Appl. No.: 18/885,497

(22) Filed: Sep. 13, 2024

(30) Foreign Application Priority Data
Oct. 23, 2023 (CN) 2023113743035

(51) Int. Cl. G06F 30/398; G06F 115/12; G06N 5/01; H01L 21/67

(52) U.S. Cl. CPC G06F 30/398; G06N 5/01; H01L 21/67144; G06F 2115/12

(57) ABSTRACT

A method for optimizing the placement process of a surface mounter using a heuristic adaptive tabu search is presented, relevant to surface-mount technology. The method includes encoding and decoding heuristic adaptive information link, where encoded information cover component allocation sequence, head sequence, heuristic algorithm selection, and pick-and-place path optimization sequence. The decoded results configure the component allocation algorithm and pick-and-place path optimization algorithm, and the optimized placement process is derived using these configured algorithms. The component allocation algorithm includes both the available feeder-oriented heuristic algorithm and the assigned feeder group-oriented heuristic algorithm, suitable for different feeder scenarios. Optimizing the selection of these algorithms achieves adaptive optimization for various production scenarios. The tabu search algorithm conducts neighborhood search operations on the adaptive information link, addressing component allocation and pick-and-place path optimization simultaneously. This approach synergistically optimizes the number of equivalent pick-up operations and pick-and-place path length, significantly enhancing production efficiency.

### CROSS REFERENCE OF RELATED APPLICATION

This is a non-provisional application that claims priority to Chinese application number 2023113743035, filing date Oct. 23, 2023, the entire contents of each of which are expressly incorporated herein by reference.

### BACKGROUND OF THE PRESENT INVENTION

The invention relates to optimization methods for the surface mounting technology of surface mounters, in particular to a method for optimizing the placement process of surface mounters, and belongs to the field of electrical technology and electrical engineering.

### DESCRIPTION OF RELATED ARTS

The growth in the importance of electronic equipment in modern production and life leads increasingly higher production requirements for high density, high complexity, large scale and flexibility of printed circuit boards (PCBs). Surface mounting technology (SMT), as the mainstream technology for producing PCBs, has witnessed a rapid development. Wherein, fully automatic surface mounters, as the key and most complex equipment on SMT production lines, can quickly, accurately and fully automatically place SMT components to corresponding positions of PCBs to greatly improve electronics manufacturing efficiency and quality and can process components of different sizes and shapes. The surface mounters have the advantages of being high in efficiency, accuracy and reliability, and capable of saving labor resources and reducing man-made errors, thus having become indispensable for modern electronics manufacturing. The pick-and-place process of the surface mounters is the most time-consuming stage on SMT production lines and is also the key to the improvement in SMT production efficiency. The invention provides a scheme for joint optimization of the pick-and-place process to remarkably improve the SMT production efficiency.

The “fully automatic surface mounter” is a beam-type single-gantry surface mounter, heads of which are arranged in a line. Different from rotary type surface mounters and turret type surface mounters, the single-gantry surface mounter is provided with only one gantry which drives a carrier to perform pick-and-place work.

The PCB mainly functions for providing mechanical support and electrical connection for electronic components and allows the electronic components to be connected by wires and solder points to form a complete circuit.

“SMT components” are placed on bonding pads by the surface mounting technology to realize electrical connection and are distinguishable from direct-plug components which are electrically connected to bonding pads by means of electrical pins penetrating through through-holes of the PCB. In this patent, only “SMT components” are taken into account and called “component” for short.

The pick-and-place process (PAP process, for short) is an entire production task performed by the fully automatic surface mounter to produce a PCB.

“Pick-and-place optimization” refers to a process of obtaining an output result (a solution to the pick-and-place optimization problem) by optimizing an algorithm design, writing codes to obtain pick-and-place process optimization software and finally running the pick-and-place process optimization software.

As shown in FIG. 2 which illustrates the mechanical structure of the beam-type single-gantry surface mounter, the beam-type single-gantry surface mounter, as one of movable-arm surface mounters, has the following structural features:

### Movement Mechanism

The main structure of the surface mounter is a three-axis movement platform which realizes horizontal movement by means of three linear guideways, wherein two parallel guideways are called “stationary arms” and synchronously controlled by two servo motors, the linear guideway perpendicular to the stationary arms is called a “gantry” and controlled by a servo motor, the stationary arms drive the gantry to move in a Y-axis direction, the gantry drives the carrier to move in an X-axis direction, and the heads are pulled by a Z-axis motor to move in a Z-axis direction and are driven by an R-axis motor to rotate (this movement is called R-axis movement).

### Component Pickup Mechanism

The heads carried by the carrier are hollow and connected to a vacuum pump, the vacuum pump pumps air out of the heads to create a vacuum environment, nozzle mounting holes are formed in bottoms of the heads and used for assembling and disassembling nozzles, there are different types of nozzles, and the tail ends of different types of nozzles have different shapes and areas, and with the increase in the area of the tail ends of the nozzles, the nozzles can generate a greater suction force to pick up large-sized components.

### (3) Component Feeding Mechanism

Components are loaded on feeders, and the feeders are arranged on a feeder base and generally inserted into slots of the feeder base to be fixed. There are three types of feeders in total: tape feeders, stick feeders and tray feeders. This patent only involves optimal assignment of the tape feeders, and the stick feeders and the tray feeders are scheduled and allocated by operators.

Belt trays are mounted at rear ends of the tape feeders and are one of the most common component packages on the market, component pickup windows are formed in front ends of the tape feeders, and after components in the pickup windows are picked up under the traction of mechanical structures, new components will be automatically fed by the tape feeders.

The whole component pickup process is implemented by the cooperation of all mechanisms. The heads move to the positions exactly above the pickup windows of the feeders where components to be picked are located and then descend until the lower surfaces of the nozzles are located near upper edges of the components, the vacuum pump creates a vacuum environment to allow the components to be sucked on the nozzles, and then the heads descend to a safety position.

### Component Placement Mechanism

Before placement of the surface mounter, a PCB to be assembled is conveyed by a conveyor belt to the working area of the surface mounter; when conveyed to a stopper of the conveyor belt of the surface mounter, the PCB will be stopped, and at this moment, a pneumatic platform of the surface mounter ascends to clamp the PCB for placement.

The whole component placement process is completed by the cooperation of all mechanisms. After picking up components, the heads move to be located above positions where the components are to be placed, then descend until the lower surfaces of the components come slightly in contact with the upper surface of the PCB, and at this moment, the vacuum pump blows air to apply a downward pressure to the components; because placement points of the PCB are coated with a viscous solder paste or binder, the components can be adhered to the surface of the PCB; and then the heads ascend to a safety height.

### (5) Nozzle Replacement Mechanism

The automatic nozzle replacement mechanism is used to allow the heads to automatically replace nozzles during PCB production, the nozzle replacement mechanism is called “auto nozzle changer” for short, and the auto nozzle changer is provided with a series of holes for mounting the nozzles (called “nozzle holes” for short).

When nozzles need to be are installed, the heads move to be located above the nozzles to be replaced, snap springs in the nozzle holes are opened, and the heads descend to pick up the nozzles and then ascend to a safety height; when the nozzles need to be detached, the heads move to be located above the nozzles to be replaced, the snap springs are opened to allow the nozzles to descend to a specified height and are then closed, and the heads ascend, such that the nozzles are detached from the heads.

### Detection Device

The fully automatic surface mounter is provided with two types of detection devices, one of which is arranged on the carrier to realize quick detection of small and medium-sized components and the other is a stationary camera device which has a larger field of view and is used for detecting large-sized components.

The whole surface mounting process comprises multiple pick-and-place cycles, and a total number of the pick-and-place cycles is indicated by K hereinafter, index numbers of the pick-and-place cycles are indicated by k∈{1,2, . . . ,K}, and the whole pick-and-place cycle includes a pickup process and a placement process. As shown in FIG. 3, the operating process of the beam-type single-gantry surface mounter is as follows.

Step 1, a PCB is conveyed by the conveyor belt; whether the PCB is conveyed in position is detected by a sensor; if the PCB is conveyed in position, the pneumatic platform ascends to clamp the PCB, and then the number of the pick-and-place cycles is set to 1; otherwise, Step 1 is performed again;

Step 2, the carrier moves to the feeder base, indexes of heads in simultaneous pickup group in the current pick-and-place cycle are obtained, and the heads move to positions above corresponding feeder slots to perform a pickup operation;

Step 3, if there are heads that fail to complete the pickup operation in the current pick-and-place cycle, the indexes of the heads in the simultaneous pickup group are updated, and Step 2 is performed again; otherwise, Step 4 is performed;

Step 4, the carrier moves to be located above the PCB, the index of the head corresponding to the current placement point is obtained, and the head moves to the placement point to perform a component placement operation;

Step 5, if there are heads that fails to complete the placement operation in the current pick-and-place cycle, the index of the head corresponding to the next placement point in the current pick-and-place cycle is updated, and Step 4 is performed; otherwise, Step 6 is performed; and

Step 6, if placement of all the pick-and-place cycles is completed, production is ended; otherwise, the number of the pick-and-place cycles is increased by 1, and Step 2 is performed.

A final optimization objective of the placement process of the surface mounter is realize a minimum total production time of the surface mounter. According to the actual production process of the surface mounter, the final optimization objective is divided into a plurality of sub-objectives: a minimum number of pick-and-place cycles, a minimum number of nozzle replacements, a maximum number of simultaneous pickups, and a minimum length of the pick-and-place path. “Simultaneous pickup” refers to a case where h heads can pick up components from the pickup windows simultaneously, and this case is defined as an equivalent pickup operation. Compared with a case where the heads pick components one by one, the number of pickup operations is reduced by (h−1). The whole pick-and-place process includes four the lengths of four paths: the path for the carrier to move to the first pickup point to pick up a component, the path for the carrier to sequentially move to subsequent pickup points to pick up components, the path for the carrier to move to the first placement point for component placement after all the heads pick up components, and the path for the heads to sequentially move to the corresponding placement points for subsequent component placement. The minimum length of the pick-and-place path is a minimum sum of the lengths of the four paths.

An optimization result of the placement process of the surface mounter comprises: a feeder assignment result: component numbers of components picked up and placed by the heads in the pick-and-pace cycles (the “component numbers” are serial numbers of components which are sequentially numbered in a PCB data file in sequence); types of nozzles mounted on the heads in the pick-and-place cycles, which describe the assignment of different feeders on the feeder base (which type of components are provided by the feeders); pickup coordinates and pickup sequence of the heads in each pick-and-place cycle, which indicate the movement path and sequence of the heads to pick up components; placement coordinates and sequence, which indicate the position coordinates and placement sequence of components in the placement process and specify the placement positions and sequence of the components.

The optimization problem of the placement process of the surface mounter includes two main sub-problems: “head task assignment problem” and “pick-and-place path optimization problem”, which have been solved by previous study. Head task assignment mainly includes nozzle assignment, component allocation and the division of all pick-and-place cycles into a plurality of “sub-cycles”, wherein each sub-cycle corresponds to all adjacent pick-and-place cycles with a same head task. Patent No. 201810829630.8 provides an approach for placement head tasks assignment, which designs a heuristic algorithm for nozzle assignment and a heuristic algorithm for component allocation. The optimization objectives of a minimum number of pick-and-place cycles, a minimum number of nozzle replacements and a minimum number of trips between the auto nozzle changer are fulfilled by nozzle assignment. Component allocation involves determination of the types of components to be placed by the heads in the pick-and-place cycles and grouping of feeders that can pick up components simultaneously and fulfils the optimization objective of a maximum number of simultaneously picked-up components. Reference Document 2 provides a pick-and-place path optimization method, which, on the basis of fulfilling head task assignment, designs a heuristic algorithm for placement point allocation, placement sorting and feeder slot allocation to finally determine the movement path of the carrier in the pick-and-place cycles. Based on existing study, the invention provides a method for optimizing the placement process of surface mounters to jointly solves the “head task assignment problem” and the “pick-and-place path optimization problem”.

Existing study has the following major defects: existing optimization methods for the placement process of surface mounters have not yet realized joint optimization of all sub-problems, cannot realize effective optimization in a production scenario where the number of available feeders is limited, and cannot overcome the drawbacks of insufficient adaptivity of heuristic algorithms; and after optimization, the number of equivalent pickup operations is excessive, and the pick-and-place path is overly long, leading to an excessively long total production time of the surface mounters and low SMT production efficiency of the surface mounter.

### SUMMARY OF THE PRESENT INVENTION

To solve the problems that existing optimization methods for the placement process of surface mounters have not yet realized joint optimization of all sub-problems, cannot realize effective optimization in a production scenario where the number of available feeders is limited, and cannot overcome the drawbacks of insufficient adaptivity of heuristic algorithms and that after optimization, the number of equivalent pickup operations is too large and the pick-and-place path is too long, leading to an excessively long total production time of the surface mounters and low SMT production efficiency of the surface mounter, the invention provides a method for optimizing the placement process of surface mounters based on heuristic adaptive tabu search.

The method for optimizing the placement process of surface mounters based on heuristic adaptive tabu search specifically comprises the following steps:
invoking a heuristic adaptive information link encoding algorithm to encode a component allocation problem and a pick-and-place path optimization problem to obtain encoded information that comprises a sequence of component allocation of nozzle rows, a head sequence in a component allocation result, a selected component allocation heuristic algorithm, and a sequence of pick-and-place path optimization of sub-cycles;
invoking a heuristic adaptive information link decoding algorithm to decode the encoded information, configuring the component allocation heuristic algorithm and a pick-and-place path optimization heuristic algorithm according to a decoding result, and obtaining a placement process optimization result using the configured heuristic algorithms, wherein the component allocation heuristic algorithm is an available feeder-oriented heuristic algorithm or an assigned feeder group-oriented heuristic algorithm, and the available feeder-oriented heuristic algorithm and the assigned feeder group-oriented heuristic algorithm provide a best optimization result respectively in a production scenario where the number of feeders is sufficient and a production scenario where the number of feeders is limited; and
determining whether a current number of unimproved searches is less than an unimproved tabu search upper limit; if so, performing a neighbor search operation on a heuristic adaptive information link to obtain a current heuristic adaptive information link, invoking the heuristic adaptive information link decoding algorithm to decode the current heuristic adaptive information link to obtain a corresponding placement process optimization result as a candidate solution, updating a current solution according to the candidate solution and a tabu list, updating the tabu list, and determining whether the current number of unimproved searches is less than the unimproved tabu search upper limit again; if not, outputting a current placement process optimal result obtained by searching; and performing SMT production, by a surface mounter, according to a component allocation result Cpg, a placement point allocation result PA, a placement sorting result PS, and a pickup slot allocation result FA and a pickup sorting result FP in each sub-cycle output by the algorithm.

### The Invention has the Following Beneficial Effects

According to the method for optimizing the placement process of surface mounters based on heuristic adaptive tabu search disclosed by the invention, a heuristic algorithm is designed for the production scenario where the number of available feeders is limited, and then, a placement process optimization method using tabu search as a high-level algorithm to schedule low-level heuristic algorithms is proposed; the nozzle row allocation sequence, head sorting and selection of the component allocation algorithm are optimized by encoding a component allocation information link, and the sequence of pick-and-place cycles participating in path optimization is optimized by encoding a pick-and-place path optimization sequence information link, such that joint optimization of sub-problems and adaptive optimization in all production scenarios are realized, thus optimizing all objectives as a whole, increasing the number of equivalent pickup operations, effectively shortening the length of the pick-and-place path, reducing the total production time of surface mounters, and finally remarkably improving the SMT production efficiency. Experiments show that the method provided by the invention can greatly improve the production efficiency of surface mounters, and compared with commercial software, can shorten the production time of the surface mounters by 35.79%.

Specifically, the invention has the following two innovations:
(1) A solution architecture that can realize joint optimization of sub-problems and adaptive optimization in all production scenarios is provided, the design of the component allocation heuristic algorithm is improved, and the production scenario where the number of available feeders is limited is further taken into account to realize collaborative optimization of all optimization objectives;
(2) The placement process optimization method using tabu search as a high-level algorithm to schedule low-level heuristic algorithms is proposed, methods for encoding and decoding setting information in different dimensions of the heuristic algorithms are provided, and the advantages of the heuristic algorithms and the advantages of meta-heuristic algorithms are effectively combined, thus realizing efficient and reliable global adaptive optimization.

### BRIEF DESCRIPTION OF THE DRAWINGS

FIG. 1 is a flow diagram of the method for optimizing the placement process of surface mounters according to the invention;

FIG. 2 is a schematic diagram of the mechanical structure of a surface mounter, wherein \textcircled{1} is a beam type carrier, \textcircled{2} is heads, \textcircled{3} is nozzles, \textcircled{4} is a PCB, \textcircled{5} is SMT components, \textcircled{6} is feeders, \textcircled{7} is a front feeder base, \textcircled{8} is a conveyor belt, \textcircled{9} is a moving guideway, \textcircled{10} is fixed guideways, \textcircled{11} is a rear feeder base, and \textcircled{12} is an automatic nozzle changer.

FIG. 3 is a flow diagram of the placement process of a surface mounter; FIG. 4 is a schematic diagram of a pick-and-place path obtained by commercial software; FIG. 5 is a schematic diagram of a pick-and-place path obtained according to the invention; FIG. 6 illustrates a convergence curve of the total production time of a surface mounter according to one embodiment to the invention; FIG. 7 illustrates a convergence curve of the number of equivalent pickup operations according to one embodiment to the invention; FIG. 8 illustrates a convergence curve of the length of the pick-and-place path according to one embodiment to the invention.

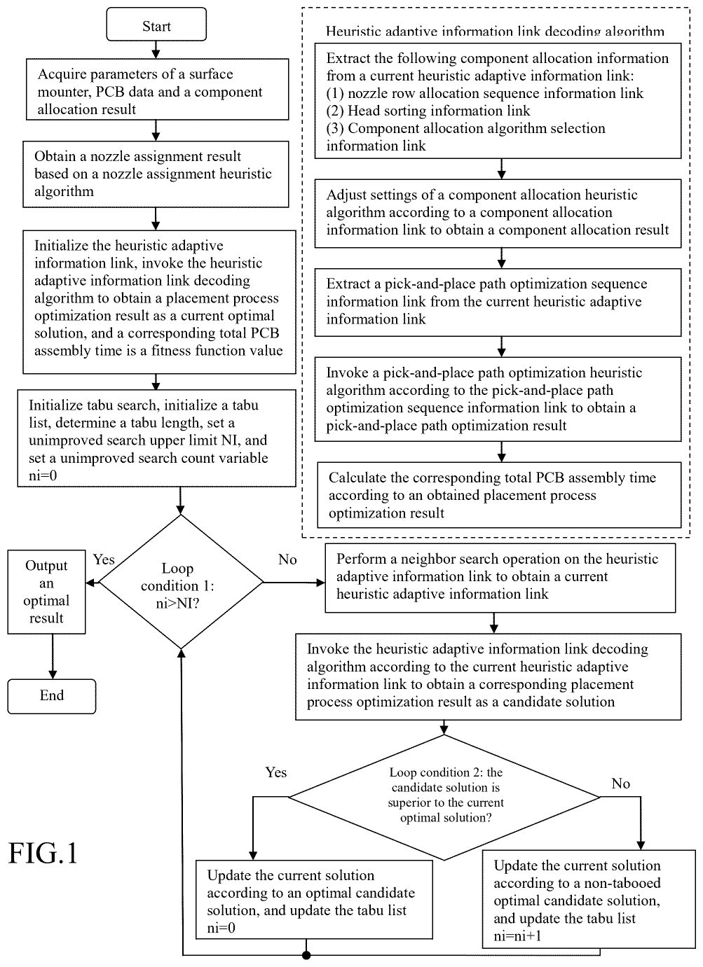

### DETAILED DESCRIPTION OF THE PREFERRED EMBODIMENT

Specific Embodiment 1: This embodiment provides a method for optimizing the placement process of surface mounters based on heuristic adaptive tabu search, comprising the following steps:
Step 1, acquiring parameters of a surface mounter and PCB production data;
Step 2, obtaining nozzle assignment results based on nozzle assignment heuristic algorithm;
Step 3, initializing heuristic adaptive information links;
Step 4, invoking heuristic adaptive information link decoding algorithm:
decoding component allocation information link CpAlink;
executing component allocation algorithm according to component allocation information link decoding result to complete component allocation to obtain component allocation result Cpg;
performing path optimization in all pick-and-place cycles according to PAPlink, and updating pick-and-place path optimization results;
calculating a corresponding total PCB assembly time TotalCost according to nozzle assignment result, component allocation result, and pick-and-place path optimization result;
initializing an optimal total assembly time TotalCostbest=TotalCost, and then performing Step 5;
Step 5, initializing tabu search parameters, initializing a tabu list, and determining a tabu length and an unimproved tabu search upper limit;
Step 6, determining whether current number of unimproved tabu search is less than the unimproved tabu search upper limit; if so, performing Step 7; otherwise, performing Step 9;
Step 7, performing a neighbor search operation on heuristic adaptive information link to obtain current heuristic adaptive information link, invoking heuristic adaptive information link decoding algorithm to decode current heuristic adaptive information link to obtain corresponding placement process optimization result as a candidate solution, and performing Step 8;
Step 8, updating current solution according to the candidate solution and the tabu list, updating the tabu list, and returning to Step 6;
Step 9, outputting current placement process optimal results obtained by searching, which specifically comprises:
performing SMT production by the surface mounter according to the component allocation result Cpg, placement point allocation result PA, placement sorting result PS, and pickup slot allocation result FA and pickup sequence result FP in each sub-cycle output by the algorithm.

Specific Embodiment 2: This embodiment is different from Specific Embodiment 1 in that in Step 1, the parameters of the surface mounter and the PCB production data are acquired specifically as follows:
same component types are interpreted as components with same component type names. Component types in PCB data file to be assembled are counted to obtain a total number C, which numbered as c∈{1, 2, . . . , C} according to an sequence in which component types appear in PCB data file. The number of component types are called component number, and the number of placement points corresponding to one type of components is called the number of placement points corresponding to the component number; the number of placement points corresponding to component type refers to the number of all placement points corresponding to components of this type on the PCB;
types of nozzles used for producing the PCB are obtained according to the data file of the PCB and a component information file, and the types of nozzles are numbered as n∈[1, . . . ,N] in a decreasing order according to the number of placement points corresponding to the types of nozzles, wherein N is a total number of the types of nozzles, numbers of the nozzles are called nozzle number; the number of placement points corresponding to each type of nozzles is saved in Pn, wherein Pn indicates the number of placement points corresponding to the nozzle number n;
a surface mounter operator manually sets a maximum number of each type of available nozzles according to the stock of nozzles and the type of the surface mounter and saves it in linNz, wherein linNz (n) indicates the number of available nozzles corresponding to the nozzle number n;
a total number of heads of the surface mounter is set as H, and indexes of the heads are numbered as h∈[1, . . . ,H] in an increasing order along an X-axis;
a total number of placement points is set as Q, and indexes of the placement points are numbered as q∈[1, . . . ,Q];
a total number of pick-and-place cycles is set as K, and indexes of the pick-and-place cycles are numbered as k∈[1, . . . ,K];
a K-row and H-column two-dimensional array PS, all elements of which are 0, is initialized to be used for saving a placement sorting result, wherein an element PS(k,s) of PS indicates s^{th} head for placement in k^{th} pick-and-place cycle, PS(k,s)∈[1, . . . ,H];
the component allocation result is saved in a K-row and H-column two-dimensional array PA, wherein an element PA(k,h) of PA indicates the type of the component picked up and placed by h^{th} head in k^{th} pick-and-place cycle, PA(k,h)∈[1, . . . ,C];
Indexes of types of feeders are numbered as f∈{1, 2, . . . ,F}, wherein F is a total number of types of feeders;
a slot allocation result of feeder groups is saved in a one-dimensional array PS, a pickup slot allocation result in each sub-cycle is saved in FA, and a pickup sorting result is saved in FP, wherein FA and FP are both K-row and H-column two-dimensional arrays;
component numbers corresponding to each type of components are saved in pcb_cp_type_cp_lib_index;
feeder numbers corresponding to each type of components are saved in pcb_cp_type_fd_lib_index;
nozzle numbers corresponding to each type of components are saved in pcb_cp_type_nz_lib_index;
wherein, pcb_cp_type_cp_lib_index, pcb_cp_type_fd_lib_index and pcb_cp_type_nz_lib_index are all one-row and C-column arrays.

Other steps and parameters in this embodiment are identical with those in Specific Embodiment 1.

Specific Embodiment 3: This embodiment is different from Specific Embodiment 1 or 2 in that in Step 2, the nozzle assignment result is obtained based on the nozzle assignment heuristic algorithm specifically as follows:

Referring to Step 4 of the approach for placement head tasks assignment of beam-type single-gantry surface mounters disclosed by US201810829630.8, the nozzle assignment result is obtained based on the nozzle assignment algorithm, that is, nozzle numbers corresponding to the heads in the pick-and-place cycles are obtained.

The nozzle assignment result is saved in a numNZl-row and H-column array NZg, which is formed by a series of nozzle combination results and has numNZl nozzle row, wherein the “nozzle row” refers to one nozzle combination result, for example, in the first nozzle row NZg(1,:)=[1 1 1 2 3 4], 1, 2, 3 and 4 are both nozzle numbers and indicate that nozzle 1 are mounted on heads 1, 2 and 3, nozzle 2 is mounted on head 4, nozzle 3 is mounted on head 5, and nozzle 4 is mounted on head 6;

It should be noted that “:” indicates that all values in a dimension are obtained by auto-increment, and NZg(k,:) indicates the acquisition of all elements in a k^{th} placement sorting chromosome; specifically:
“1:1:H” indicates the acquisition of an array from 1 to H with an increment 1, that is, [1, . . . ,H]; “H:−1:1” indicates the acquisition of an array from H to 1 with an increment −1, that is [H,H−1, . . . ,1]; because auto-increment (increment 1) search is used frequently, 1:1:H is abbreviated as NZg(k,1:H); when the array is indexed, if the first value is 1, the last value will be exactly the number of elements in this dimension, so NZg(k,1:H) can be further abbreviated as NZg(k,:);
floorNzCyc is a one-row and numNZl-column array, and each element in floorNzCyc indicates the serial number of the first pick-and-place cycle in one nozzle row;
numKinNZ1 is a one-column and numNZl-column array, and each element in numKinNZ1 indicates the number of all pick-and-place cycles in one nozzle row.

Other steps and parameters in this embodiment are the same as those in Specific Embodiment 1 or 2.

Specific Embodiment 4: This embodiment is different from Specific Embodiments 1-3 in that in Step 3, the heuristic adaptive information link is initialized specifically by the following steps:
Step 31, initializing and assigning the nozzle rows to obtain a sequence array SeqNzl=1:K for component allocation, wherein elements in the sequence array indicate component allocation sequences in the pick-and-place cycles, for example, if SeqNzl(5) is 7, it indicates that component allocation will be performed for the nozzle row corresponding to the seventh pick-and-place cycle in the fifth round;
a component allocation algorithm selection information link SeqCpAa is a one-row and K-column array, and elements in SeqCpAa indicate types of component allocation algorithm adopted when component allocation is performed for the nozzle rows; if the element is 1, an available feeder-oriented component allocation algorithm is adopted to perform Step 426; if the element is 0, an assigned feeder group-oriented component allocation algorithm is adopted to perform Step 427;
initializing and assigning component allocation algorithm selection link Seq01link=1:1:2K, wherein elements in Seq01link indicate indexes of the component allocation algorithms, Seq01Bin is defined as a one-row and 2K-column array, first K columns in Seq01Bin are 1, last K columns in Seq01Bin is 0, and with each value in Seq01link as an index, values corresponding to Seq01Bin are obtained according to SeqCpAa, for example, if Seq01link(5) is 7, it indicates the seventh element in Seq01 Bin; if Seq01Bin(7)=0, it indicates SeqCpAa(5)=0, that is, the assigned feeder group-oriented component allocation algorithm is adopted to perform Step 427; or, if Seq01Bin(7)=1, it indicates SeqCpAa(5)=1, that is, the available feeder-oriented component allocation algorithm is adopted to perform Step 426;
initializing and assigning a head sequence SeqHd=1:1:H used for component allocation SeqHd=1:1:H, wherein for example, if SeqHd(2)=2, it indicates that the sequence of head 2 during component allocation is 2;
initializing a component allocation information link CpAlink, wherein CpAlink is a one-row and (3*K+H)-column array formed by splicing SeqNZl, Seq01link and SeqHd, value intervals are used for a distinguishing purpose, each value in SeqNZl is added by 30000, each value in Seq01link is added by 20000, and each value in SeqHd is added by 10000, and then the three modified arrays are spliced to form CpAlink;
where, * is a multiplication sign; SeqNZl is a sub-cycle allocation sequence array, Seq01link is the component allocation algorithm selection link, SeqHd is a head allocation array, Seq01Bin is an algorithm selection binary array, and SeqCpAa is component allocation algorithm selection information;
Step 32, initializing a pick-and-place path optimization sequence information link PAPlink, wherein the pick-and-place path optimization sequence information link is a one-row and K-column array, and PAPlink=1:1:K;
a heuristic adaptive information link HATSlink is a one-row and (4*K+H)-column array formed by splicing CpAlink and PAPlink.

Other steps and parameters in this embodiment are the same as those in Specific Embodiments 1-3.

Specific Embodiment 5: This embodiment is different from Specific Embodiments 1˜4 in that in Step 4, the process of invoking the heuristic adaptive information link decoding algorithm comprises:
decoding a component allocation information link CpAlink;
executing component allocation algorithm according to component allocation information link decoding result to complete component allocation to obtain component allocation result Cpg;
performing path optimization in all pick-and-place cycles according to PAPlink, and updating a pick-and-place path optimization result;
calculating a corresponding total PCB assembly time TotalCost according to the nozzle assignment result, the component allocation result, and the pick-and-place path optimization result;
initializing an optimal total assembly time TotalCostbest=TotalCost, and then performing Step 5;
specifically:

Step 41, decoding the component allocation information link CpAlink specifically as follows:

Step 411, using a numNZl-row and two-column array idxCyc to locate a current nozzle row number and pick-and-place cycle number under operation, wherein data in the first row of idxCyc indicate the number of the nozzle row under allocation in the nozzle assignment result NZg, data in the second row of idxCyc indicate the serial number of the first pick-and-place cycle to be allocated in the current nozzle row, for example, idxCyc(1,1)=1 indicates that component row 1 of the component allocation result corresponds to nozzle row 1; idxCyc(1,2)=floorNzCyc(1) indicates that component row 1 of the component allocation result corresponds to the current first pick-and-place cycle floorNzCyc(1); one component row indicates an array formed by numbers of the types of components picked up and placed by the heads in one sub-cycle;
Step 412, saving data information greater than 30000 in the component allocation information link CpAlink in the sub-cycle allocation sequence array SeqNZl, and subtracting 30000 from the data to obtain actual values;
Step 413, saving data information greater than 20000 in the component allocation information link CpAlink the component allocation algorithm selection link Seq01link, and subtracting 20000 from the data to obtain actual values;
obtaining the component allocation algorithm selection information SeqCpAa=Seq01Bin (Seq01link) according to the component allocation algorithm selection link Seq01link and the algorithm selection binary array Seq01Bin;
Step 414, saving data information greater than 10000 in the component allocation information link CpAlink in the head allocation array SeqHd, and subtracting 10000 from the data to obtain actual values;
Step 42, performing the component allocation algorithm according to the component allocation information link decoding result to complete component allocation to obtain the component allocation result Cpg;
wherein, Cpg is an H-column two-dimensional array; elements in Cpg indicate the types of components picked and placed by the heads in the sub-cycles, for example, Cpg(4,3)=18 indicates that a component to be picked and placed by the third head in the fourth sub-cycle is of type 18;
Step 43, performing path optimization in all pick-and-place cycles according to PAPlink, and updating the pick-and-place path optimization result specifically as follows:
wherein, PAPlink is the pick-and-place path optimization sequence information link;
Step 431, initializing a pick-and-place cycle count variable cntK=1, wherein the pick-and-place cycle count variable cntK is used for counting pick-and-place cycles that have completed path optimization;
Step 432, determining whether cntK>K, that is, determining whether path optimization of all the pick-and-place cycles have been completed; if so, determining that path optimization of all the cycles has been completed, and performing Step 44; if not, performing Step 433;
Step 433, obtaining a current cycle idxK=PAPlink(cntK) under optimization according to the pick-and-place path optimization sequence information link PAPlink;
Step 434, with reference to the path optimization method in Literature (H. Gao, Z. Li, X. Yu and J. Qiu, “Hierarchical multiobjective heuristic for PCB assembly optimization in a beam-head surface mounter),” IEEE Trans. Cybern., vol. 52, no. 7, pp. 6911-6924 July 2022, performing path optimization on the (idxK)^{th} pick-and-place cycle to obtain pick-and-place path optimization result: placement point allocation result PA(idxK,:), placement sorting result PS(idxK,:), and pickup slot allocation result FA (idxK,:) and pickup sorting result FP (idxK,:) in each sub-cycle;
Step 435, updating the count variable cntK=cntK+1, and returning to Step 432; Step 44, calculating the total PCB assembly time TotalCost:
obtaining a total movement distance total_dis of a head assembly according to the pick-and-place path optimization result, and calculating the total PCB assembly time TotalCost=total_dis/v based on the total movement distance total_dis of the head assembly and an average movement speed v of the head assembly;
Step 45, initializing the total PCB assembly time TotalCost, and then performing Step 5.

Other steps and parameters in this embodiment are the same as those in Specific Embodiments 1-4.

Specific Embodiment 6: This embodiment is different from Specific Embodiments 1-5 in that in Step 42, the specific process of performing component allocation algorithm according to the component allocation information link decoding result to complete component allocation to obtain the component allocation result Cpg specifically comprises:
Step 421, initializing parameters related to component allocation specifically as follows:
Step 4211, obtaining nozzle assignment result NZgs=NZg(:,SeqHd) after the heads are rearranged according to SeqHd;
wherein, SeqHd is head sequence during component allocation, NZgs is the nozzle assignment result after the heads are rearranged, and NZg(:,SeqHd) is a nozzle assignment result sequentially read according to SeqHd;
Step 4212, sumSP=0, NZg0=NZgs, numKinCpl=numKinNZl;
wherein, the variables umSP is the number of pickup operations reduced by means of simultaneous pickup;
the variableNZg0 is a nozzle assignment result obtained according to the sub-cycles for component allocation;
the variable numKinCpl is the number of pickup cycles in each component row;
the variable numKinNZl is the number of pick-and-place cycles in each nozzle row;
Step 4213, saving a temporary component allocation result under update in CPg0;
wherein, flagNZg0 is a flag array indicating that allocation of nozzle rows under update has been completed and is a one-row and numNZl-column array, and elements in flagNZg0 indicate whether component allocation of the nozzle rows has been completed;
numFdLim0 is a one-row and C-column array and indicates available feeders under update, and elements in the numFdLim0 indicate the numbers of available feeders corresponding to different types of components;
Fdg0 indicates feeder groups under update and is initialized into an empty array;
numFdg0 indicates the number of feeder groups under update and is initialized to 0;
numSPH0 indicates the number of different simultaneous pickup types under update and is initialized into a one-row and H-column array, the values of which are 0;
numPtinCp0 indicates the number of placement points corresponding to different types of components under update and is a one-row and C-column array, and elements in numPtinCp0store the number of placement points corresponding to non-allocated components;
the simultaneous pickup type refers to a possible case of simultaneous pickup of components on multiple feeders at one position when components on the feeders of the surface mounter are picked up, the number of the simultaneous pickup types corresponds to the number of the heads, and there are totally H simultaneous pickup types SP1-SPH, for example, SP2 indicates that when a pickup action is performed at this position, two heads can simultaneously pick up components from two feeders;
wherein, numNZl is a total number of the nozzle rows, and CPg0 is the temporary component allocation result; and
Step 4214, numCPl0=numNZl, idxCyc0=idxCyc, sumSP0Max=−1, numNZl0K=0, cntK=0;
wherein, numCPl0 is the number of component rows under update;
idxCyc0 is an index array of cycles under update;
sumSP0Max is a maximum simultaneous pickup count variable and is initialized to −1, and there will be no simultaneous pickup after component allocation, so this variable is set to 0;
numNZl0K is used for saving nozzle rows that have completed component allocation;
cntK is used for counting pick-and-place cycles that have completed component allocation, is also used as a coded information index, and is initialized to 0;
numNZl is a total number of nozzle rows;
idxCyc is used for locating the current nozzle row number and pick-and-place cycle number under operation;
Step 422, determining whether the number numNZl0K of nozzle rows that have completed component allocation is less than the total number numNZl of nozzle rows; if so, performing Step 423; otherwise, returning to Step 43;
Step 423, saving the current temporary component allocation result in a temporary variable, and determining whether component allocation has been completed specifically as follows:
Step 4231, NZg0T=NZg0, numKinCplT=numKinCpl, CPgT1=CPg0, flagNZgT=flagNZg0, numFdLimT1=numFdLim0, FdgT1=Fdg0, numFdgT1=numFdg0, numSPHT1=numSPH0, numPtinCpT1=numPtinCp0, numCPlT1=numCPl0, idxCycT1=idxCyc0, cntK=cntK+1;
wherein, NZg0T is a temporary nozzle assignment result variable, and NZg0 is the nozzle assignment result obtained according to the sub-cycles for component allocation;
numKinCplT is a temporary variable of the number of pick-and-place cycles in each component row, and numKinCpl is the number of pick-and-place cycles in each component row;
CPgT1 saves the temporary component allocation result, and CPg0 is the temporary component allocation result under update;
flagNZgT is a flag array indicating that allocation of temporary nozzle rows has been completed, and flagNZg0 is a flag array indicating that allocation of nozzle rows under update has been completed;
numFdLimT1 is an array of the number of temporary available feeders, and numFdLim0 is an array of available feeders under update;
FdgT1 indicates temporary feeder groups, and Fdg0 indicates feeder groups under update;
numFdgT1 is the number of temporary feeder groups, and numFdg0 is the number of feeder groups under update;
numSPHT1 is the number of temporary simultaneous pickups, and numSPH0 is the number of simultaneous pickups under update;
numPtinCpT1 is the number of temporary placement points corresponding to different types of components, and numPtinCp0 is the number of placement points under update corresponding to different types of components;
numCPlT1 is the number of temporary component rows, and numCPl0 is the number of component rows under update;
idxCycT1 is an index array of temporary cycles, and idxCyc0 is an index array of cycles under update;
Step 4232, idxNZi=SeqNZl(cntK), idxNZl=idxCycT1(idxNZi,1);
wherein, idxNZi indicates an index of a current nozzle row under component allocation;
idxNZl indicates a component row corresponding to the component allocation result;
SeqNZl(cntK) is data in the (cntK)^{th} row of the sub-cycle allocation sequence array;
idxCycT1 (idxNZi,1) is the number of the nozzle row corresponding to the (idxNZi)^{th} row of the index array of temporary cycles;
Step 4233, if flagNZgT (idxNZi)=1, determining that component allocation has been performed on the component row, and returning to Step 422; if flagNZgT (idxNZi)=0, determining component allocation has not been performed on the component row, and performing Step 424;
Step 424, acquiring simultaneous pickup type data according to current nozzle row information specifically as follows:
Step 4241, NZl=NZg0T(idxNZi), wherein columns that are not equal to 0 in NZl are saved in an array idxNot0, the size of which is numNot0, NZl indicates the current nozzle row under component allocation, and numbers of nozzles to be allocated in the current nozzle row are saved in idxNot0;
Step 4242, cntNzT=0, wherein cntNzT is a count variable and is used for counting the types of nozzles in the current nozzle row;
when the types of nozzles in the current nozzle row are saved in libNzT, uplimflagSpT corresponds to a simultaneous pickup type search upper limit of the types of nozzles saved in libNzT, and flagSpT corresponds to a simultaneous pickup type search count array of the types of nozzles saved in libNzT;
libNzT, uplimflagSpT and flagSpT are updated and assigned in Step 4244 and are all one-dimensional arrays;
the types of nozzles in the current nozzle row are saved in libNzT;
Step 4243, if the current nozzle row NZl under component allocation is not empty, performing Step 4244; otherwise, performing Step 425;
Step 4244, if NZl(1)=1, cntNzT=cntNzT+1, libNzT.push(NZl(1)), multiplyingnumSpT_1 greater than 1 in numSpT(NZl(1)) by numSpT(NZl(1)), and saving the product in uplimflagSpT, that is, uplimflagSpT.push(numSpT_1*numSpT(NZl(1))), flagSpT.push(0); otherwise, directly performing Step 4245;
wherein, numSpT is a one-row and numNZl-column array and saves the number of simultaneous pickup types corresponding to N types of nozzles;
“.push( )” refers to the interpolation of a value at the end of an array, for example, for an array A=[1, 2, 3], after A.push(4) is performed, the array A=[1, 2, 3] turns in to A=[1, 2, 3, 4];
cntNzT is a count variable for counting the types of nozzles in the current nozzle row, and libNzT.push(NZl(1)) indicates the interpolation of the current nozzle row under component allocation into libNzT, in which the types of nozzles in the current nozzle row are saved; numSpT(NZl(1)) is the number of simultaneous pickup types corresponding to the current nozzle row NZl(1) under component allocation, wherein numSpT indicates the number of simultaneous pickup types corresponding to different types of nozzles, numSpT_1 is the number greater than 1 in numSpT(NZl(1)), uplimflagSpT corresponds to the simultaneous pickup type search upper limit of the types of nozzle saved in libNzT, uplimflagSpT.push(numSpT_1*numSpT(NZl(1))) indicates the interpolation of a product of numSpT_1 and numSpT(NZl(1)) at the end of the array uplimflagSpT, and flagSpT.push(0) indicates the interpolation of 0 at the end of flagSpT, wherein flagSpT corresponds to the simultaneous pickup type search count array of the types of nozzles saved in libNzT;
Step 4245, removing nozzles numbers, identical with NZl(1), from the current ozzle row NZl under component allocation, and returning to Step 4243;
Step 425, before component allocation is performed column by column on the current nozzle row, selecting a component allocation algorithm strategy specifically as follows:
Step 4251, flagOKT being a flag array indicating that component allocation of the heads has been completed and being a one-row and H-column array, and elements in flagOKT indicating whether component allocation of columns in the current nozzle row has been completed, if flagOKT is 1, determining that component allocation has not been completed; if flagOKT is 0, determining that component allocation has been completed, initializing flagOKT to an all-zero array, and under an idxNot0 index, setting flagOKT to 1, indicating “not allocated”;
wherein, numKinCol is an array of the number of to-be-allocated placement points corresponding to the heads and is a one-row and H-column array, in which the number of to-be-allocated placement points in the columns in the current nozzle row is saved, and numKinCol is initialized into an all-1 array;
Step 4252, setting all values in numFdLimT2=numFdLimT1, flagOK=flagOKT, FdgPrior1=SeqCpAa (cntK and numKinCol to numKinCplT (idxNZi);
wherein, numFdLimT2 indicates an array of second temporarily used available feeders;
flagOK indicates a flag array indicating that allocation of temporarily used heads has been completed;
FdgPrior1 indicates a feeder assignment flag; if FdgPrior1=1, it indicates that allocation is performed preferably according to available feeders; if FdgPrior1=0, it indicates that allocation is performed preferably according to feeder groups;
SeqCpAa (cntK) indicates the (cntK)^{th} element in the component allocation algorithm selection information link SeqCpAa, numKinCol indicates the array of the number of to-be-allocated placement points corresponding to the heads, numKinCplT (idxNZi) indicates the (idxNZi)^{th} element in the variable of the number of pick-and-place cycles in temporary component rows, and idxNZi is an index of the current nozzle row under component allocation;
Step 4253, if FdgPrior1=1, FdgPrior2=1; otherwise, FdgPrior2=0, wherein if FdgPrior2=1, it indicates that remaining heads cannot be allocated according to feeder groups;
if FdgPrior2=0, it indicates that remaining heads can be allocated according to feeder groups;
Step 4254, cntNot0=1, flagAvailable=0;
wherein, cntNot0 is a count variable and used for counting heads to be allocated; if flagAvailable is 0, it indicates that available feeders are not used during current allocation;
Step 4255, if cntNot0 is less than numNot0, performing step 4256; otherwise, performing Step 429;
Step 4256, idxH=idxNot0(cntNot0), cntNot0=cntNot0+1;
wherein, idxH is the head number corresponding to current component allocation;
idxNot0(cntNot0) indicates the (cntNot0)^{th} element in idxNot0, wherein idxNot0 indicates columns greater than 0 in the current nozzle row under component allocation;
Step 4257, if flagOK (idxH)=1, which indicates that the current head is not allocated, performing Step 4258; otherwise, performing Step 429;
wherein, flagOK (idxH) indicates the (idxH)^{th} element in the flag array indicating that allocation of the heads has been completed, and idxH indicates the number of the current head under component allocation;
Steps 4258, saving indexes corresponding to values, equal to NZg0T(idxNZi,idxH), in libNzT in the variableidxlibNzT;
wherein, NZg0T(idxNZi,idxH) refers to the value in the (idxNZi)^{th} row and the (idxH)^{th} column in NZg0T; if flagSpT(idxlibNzT)=1, idxCpTinNzT=SpT(NZg0T(idxNZi,idxH)); otherwise, idxCpTinNzT=idx_cp_type_nz_type(NZg0T(idxNZi,idxH));
idx_cp_type_nz_type is a one-row and N-column array and saves the types of components that can be picked and placed by different types of nozzles, and SpT is a one-row and N-column array and saves the simultaneous pickup types corresponding to different types of nozzles;
idxlibNzT indicates indexes of values, equal to NZg0T(idxNZi,idxH), in libNzT, flagSpT(idxlibNzT) indicates the (idxlibNzT)^{th} element in the simultaneous pickup type search count array of the types of nozzles saved in libNzT, idxCpTinNzT indicates the simultaneous pickup type corresponding to the current type of nozzles, SpT(NZg0T(idxNZi,idxH)) indicates the simultaneous pickup type corresponding to the nozzle type in the (idxNZi)^{th} row and (idxH)^{th} column in the temporary nozzle assignment result NZg0T, and idx_cp_type_nz_type(NZg0T(idxNZi,idxH)) indicates the type of components to be placed by the current type of nozzles NZg0T(idxNZi,idxH); and
Step 4295, if FdgPrior1=1 or FdgPrior2=1, performing Step 426 preferably according to available feeders; otherwise, performing Step 427 preferably according to feeder groups;
Step 426, performing component allocation preferably according to available feeder specifically as follows:
Step 4261, flagAvailable=1, flagFdLimTmp1=numFdLimT2, setting values equal to 0 in flagFdLimTmp1 to 1, and setting values equal to 1 in flagFdLimTmp1 to 0;
wherein if flagAvailable is 1, it indicates that available feeders are used during current allocation; if flagAvailable is 0, it indicates that available feeders are not used;
flagFdLimTmp1 indicates the number of transformed available feeders, and numFdLimT2 indicates the number of available feeders;
the type of components to be allocated next is determined according to the number numPtinCpT1 of placement points to which components have not been allocated and the numbernumFdLimT2 of available feeders;
Step 4262, calculating a component selection function value numCptmp according to the number numPtinCpT1 of placement points to which components have not been allocated and the numbernumFdLimT2 of available feeders as follows:

$$numCptmp = numPtinCpT 1 ( idxCpTinNzT ) - flagFdLimTmp 1 ( idxCpTinNzT ) \times 1000$$

wherein, idxCpTinNzT indicates the simultaneous pickuptype corresponding to the current type of nozzles;
Step 4263, saving a maximum component selection function value numCptmp in a variable maxCpNum, and saving an index of the maximum value in a variable idxMaxCpNum;
wherein, maxCpNum indicates the maximum component selection function value, and idxMaxCpNum indicates the index of the maximum value;
Step 4264, if maxCpNum is equal to 0,numCptmp=numPtinCpT1 (idxCpTinNzT), saving the maximum component selection function value numCptmp in the variable maxCpNum, and saving an index of the maximum value in the variable idxMaxCpNum;
Step 4265, calculating the type of components to be allocated, idxCpT=idxCpTinNzT(idxMaxCpNum), CPgT1(idxNZi,idxH)=idxCpT;
wherein, idxCpT indicates the type of selected components to be allocated, CPgT1(idxNZi,idxH) indicates a temporary component allocation result of the (idxNZi)^{th} row and the (idxH)^{th} column, and idxCpTinNzT(idxMaxCpNum) indicates the (idxMaxCpNum)^{th} element of the simultaneous pickuptype corresponding to the current type of nozzles; and
Step 4266, updating related information of the components and the heads:
Step 42661, updating the array numFdLimT2 of the second temporarily used available feeders,

numFdLimT2(pcb_cp_type_cp_lib_index(idxCpT))=numFdLimT2(pcb_cp_type_cp_lib_index(idxCpT))−1
wherein, pcb_cp_type_cp_lib_index(idxCpT) indicates the component number corresponding to the type idxCpT of selected components to be allocated;
Step 42662, updating the flag array flagOK indicating that allocation of temporarily used heads has been completed, flagOK (idxH)=0;
Step 42663, updating the array numKinCol of the number of to-be-allocated placement points corresponding to the heads,
numKinCol(idxH)=min(maxCpNum,numKinCol(idxH))
wherein, min(maxCpNum,numKinCol(idxH)) refers to calculation of the maximum component selection function value numCptmp and a minimum value in the (idxH)^{th} column of the array of the number of to-be-allocated placement points corresponding to the heads; and
Step 42664, updating the number of temporary placement points corresponding to different types of components,

numPtinCpT1(idxCpT)=numPtinCpT1(idxCpT)−numKinCol(idxH)
wherein, numPtinCpT1 indicates the number of temporary placement points corresponding to different types of components, and numKinCol indicates the array of the number of to-be-allocated placement points corresponding to the heads;
Step 427, performing allocation preferably according to feeder groups specifically as follows:
Step 4271, idxFdgHd=1, optnumSp=0, cntFdgT=1;
wherein, idxFdgHd indicates whether allocation can be performed according to feeder groups; if idxFdgHd=1, it indicates that allocation cannot be performed according to feeder groups; if idxFdgHd=0, it indicates that allocation can be performed according to feeder groups;
the variable optnumSp is used for recording an optimal number of simultaneous pickups in the current allocation process;
cntFdgT is an ergodic count of a current feeder group;
Step 4272, if the count cntFdgTof the current feeder group is less than the number of temporary feeder groups, idxsizeFdg=1, and performing Step 4273; otherwise, performing Step 428;
wherein, idxsizeFdg indicates a count variable for NzFdg counting;
the number of components in the current feeder groups is sizeFdg, sizeFdg is equal to FdgT1(cntFdgT), the type of nozzles corresponding to the type of components in the current feeder group is saved in a variable NzFdg, which is a one-row and sizeFdg-column array, and each value in NzFdg is initialized to 0;
idxsizeFdg is a count variable for NzFdg assignment, and FdgT1(cntFdgT) indicates the (cntFdgT)^{th} elements in the temporary feeder group;
Step 4273, assigning the type NzFdg of nozzles corresponding to the type of components in the current feeder group specifically as follows:
Step 42731, if the count variableidxsizeFdg for NzFdg assignment is less than the number sizeFdg of components in the current feeder group, performing Step 42732; otherwise, performing Step 42734;
Step 42732, if FdgT1(cntFdgT) (idxsizeFdg) which indicates the (idxsizeFdg)^{th} item in FdgT1(cntFdgT) is greater than 0, NzFdg (cntFdgT)=pcb_cp_type_nz_lib_index(FdgT1(cntFdgT) (idxsizeFdg)), and performing Step 42733;
wherein, NzFdg (cntFdgT) indicates the type of the (cntFdgT)^{th} nozzle corresponding to the type of components in the current feeder group, and pcb_cp_type_nz_lib_index indicates nozzle numbers corresponding to the type of components;
Step 42733, updating the count variable for NzFdg assignment idxsizeFdg=idxsizeFdg+1, and returning to Step 42731;
Step 42734, if FdgT1(cntFdgT) (idxsizeFdg) which indicates the (idxsizeFdg)^{th} item in FdgT1(cntFdgT) is greater than 0, NzFdg (cntFdgT)=pcb_cp_type_nz_lib_index(FdgT1(cntFdgT) (idxsizeFdg)), and performing Step 42735; and
Step 42735, updating the count variable for NzFdg assignment idxsizeFdg=idxsizeFdg+1, and returning to Step 42731; and
Step 4274, looping and determining whether simultaneous pickup is available when the components in the feeder group correspond to the heads, and performing component allocation, specifically:
Step 42741, initializing the count variable i=sizeFdg−1;
wherein, sizeFdg indicates the number of components in the current feeder group;
Step 42742, if i is greater than 1-H, performing Step 42743; otherwise, performing Step 42748;
Step 42743, flagOK2=flagOK, numKinCol1=numKinCol, numPtinCp2=numPtinCpT, CPg2=CPgT1, cntSp=0;
wherein, flagOK2 is used for saving the flag array indicating that allocation of temporarily used heads has been completed, and flagOK indicates the flag array indicating that allocation of temporarily used heads has been completed;
numKinCol1 is used for saving the array of the number of to-be-allocated placement points corresponding to the heads, and numKinCol is the number of to-be-allocated placement points corresponding to the heads;
numPtinCp2 is used for saving the temporary number of placement points corresponding to different types of components, and numPtinCpT1 indicates the temporary number of placement points corresponding to different types of components;
CPg2 is used for saving the temporary component allocation result, and CPgT1 indicates the temporary component allocation result;
cntSp is used for counting simultaneous pickups;
Step 42744,minj=max((i+1), 1), maxj=min(H+i,sizeFdg), wherein the minimum value is minj, the maximum value is maxj, max(a,b) is used for selecting a greater value from 1 and b, and min(a,b) is used for selecting a smaller value from a and b; H indicates the total number of heads of the surface mounter; sizeFdg indicates the number of components in the current feeder group; i is the count variable in Step 42471 and indicates the i^{th} element in the feeder group, and j is an ergodic count variable of type of components in the feeder group used in Step 42745 and indicates the j^{th} element in the feeder group;
Step 42745, looping through the types of components in the feeder group for component allocation specifically as follows:
1, using j=minj as an ergodic count variable of the type of components in the feeder group;
2, if j is less than maxj, performing 3; otherwise, performing Step 42746;
3, idxH=j−I, idxCpT=FdgT1(cntFdgT)(j);
wherein, idxH indicates the number of heads under current component allocation, idxCpT indicates the type of components selected for component allocation, and FdgT1(cntFdgT)(j) indicates the j^{th} element in the current temporary feeder group;
4, if flagOK2(idxH) is not equal to 0, idxCpT is not equal to 0, NzFdg(j) is equal to NZg0T(idxNZi,idxH) and numPtinCp2(idxCpT) is not equal to 0, performing the following operations:
updating the simultaneous pickup count variable cntSp, cntSp=cntSp+1
updating the temporary component allocation result CPg2, CPg2(idxNZi,idxH)=idxCpT
updating and saving the temporary flag array flagOK2 indicating that allocation of heads has been completed, flagOK2(idxH)=0
updating the array numKinCol1 of the temporary number to-be-allocated placement points corresponding to heads, numKinCol1(idxH)=min(numPtinCp2(idxCpT),numKinCol1(idxH))
updating the temporary number numPtinCp2 of to-be-allocated placement points corresponding to heads, numPtinCp2(idxCpT)=numPtinCp2(idxCpT)-numKinCol1(idxH)
wherein, NzFdg(j) indicates the j^{th} type of nozzles corresponding to the type of components in the current feeder group, and CPg2(idxNZi,idxH) indicates the (idxH)^{th} element in the temporary component allocation result in the (idxNZi)^{th} row;
5, j=j+1, returning to 2;
Step 42746, if the simultaneous pickup count cntSp is greater than the current optimal number optnumSp of simultaneous pickups, updating as follows:
updating the variable idxFdgHd indicating whether allocation can be performed according to feeder groups, idxFdgHd=0
updating the optimal number optnumSp of simultaneous pickups in the current allocation process, CPg3=CPg2,
flagOK3=flagOK2, numKinCol2-numKinCol1, numPtinCp3=numPtinCp2
wherein, CPg3 is another temporary component allocation result;
flagOK3 is another temporary array indicating whether allocation of heads has been completed, and flagOK2 is the saved temporary flag array indicating that allocation of heads has been completed;
numKinCol2 is used for saving another temporary array of the number of to-be-allocated placement points corresponding to heads,
numPtinCp3 is used for saving another number of placement points corresponding to different types of components; Step 42747, i=i−1, returning to Step 42747; and
Step 42748, updating the ergodic count variable of the current feeder group, cntFdgT=cntFdgT+1, and returning to Step 4272;
Step 428, if idxFdgHd is greater than 0, performing the following operations:
updating a flag FdgPrior2 indicating whether remaining heads can be allocated according to feeder groups, FdgPrior2=1, updating the count variablecntNot0, cntNot0=cntNot0=1;
otherwise, performing the following operations:
updating the temporary component allocation result CPgT1, CPgT1=CPg3,
updating the temporary flag array flagOK indicating that allocation of heads has been completed, flagOK=flagOK3,
updating the array numKinCol of the number of to-be-allocated placement points corresponding to heads, numKinCol=numKinCol2,
updating the temporary number numPtinCpT1 of placement points corresponding to different types of components, numPtinCpT1=numPtinCp3,
updating the count variablecntNot0, cntNot0=1,
returning to Step 4255;
Step 429, saving indexes, not equal to 0, in the array numKinCol(idxNot0) of the number of to-be-allocated placement points corresponding to heads in an array idxCPgSubcyNot0, the size of which is numCPlSubcyNot0;
if numCPlSubcyNot0 is equal to numNot0, which indicates that the number of placement points corresponding to some heads is 0, indicating that the allocation is invalid, performing Step 4201; if numCPlSubcyNot0 is not equal to numNot0, returning to Step 422 to perform the next round of component allocation;
wherein, idxCPgSubcyNot0 indicates non-zero indexes of the array of the number of to-be-allocated placement points corresponding to the heads, numCPlSubcyNot0 indicates the number of non-zero indexes of the array of the number of to-be-allocated placement points corresponding to the heads, and numNot0 indicates the number of non-zero columns in the current nozzle row under component allocation; and
Step 420, with reference to Step 7 of the approach for placement head tasks assignment of beam-type single-gantry surface mounters disclosed by Patent No. 201810829630.8, further performing component allocation by means of the component allocation method, saving a component allocation result in CPg, saving a nozzle assignment result obtained according to the sub-cycles for component allocation in NZg0, updating the feeder group Fdg0 according to the nozzle assignment result, and saving the number of simultaneous pickups for different types of components in numSPH; returning to Step 422 to perform the next round of component allocation.

“Head task assignment includes nozzle assignment and component allocation and the division of all pick-and-place cycles into a plurality of “sub-cycles”, wherein one sub-cycle corresponds to all adjacent pick-and-place cycles corresponding to the same head task”. In the component allocation result, adjacent pick-and-place cycles corresponding to the same type of components are classified to one sub-cycle, and for different sub-cycles component, the allocation results are different; because different types of components may correspond to different types of nozzles, the nozzle assignment result can be obtained according to the component allocation result, and identical nozzle assignment sub-cycles will be obtained according to identical nozzle assignment results.

The other steps and parameters in this embodiment are the same as those in Specific Embodiments 1-5.

Specific Embodiment 7: This embodiment is different from Specific Embodiments 1-6 in that initializing tabu search parameters in Step 5 comprises: initializing a neighbor operation Action List, and determining a tabu length nAction and an unimproved tabu search upper limit NI, specifically:
Step 51, determining a neighbor operation list ActionList according to a variable numSeq which is equal to the sum of the length of the component allocation information link CpAlink and the total number K of pick-and-place cycles, wherein ActionList is a 2*numSeq²−numSeq-row and three-column array, a first column of which represents an operator identifier and a second column and a third column are increasing sequences;
wherein, * indicates a multiplication sign;
first

$$\frac{numSeq * ( numSeq - 1 )}{2}$$

rows are commuting operator, the operator identifier in the first column is 1, the second column is an increasing sequence from 1 to numSeq−1, and the third column is an increasing sequence from 2 to numSeq;
rows from the

$${( \frac{numSeq * ( numSeq - 1 )}{2} )}^{th}$$

row to the (numSeq*(numSeq−1))^{th} row are reversal operators, the operator identifier in the first column is 2, the second column is an increasing from 1 to numSeq-1, and the third column is an increasing sequence from 2 to numSeq;
rows from the (numSeq*(numSeq−1))^{th} row to the (2*numSeq²−numSeq)^{th} row are interpolation operators, the operator identifier in the first column is 3, the second column is an increasing from 1 to numSeq-1, and the third column is an increasing sequence from 2 to numSeq;
for example, ActionList(2) is to acquire the second row of the neighbor operation list, and ActionList(2)(1) is to acquire a value in the second row and the first column of the neighbor operation list;
Step 52, denoting the number of times of being disabled of neighbor operations in the neighbor operation list as TC, and denoting the number of times of being disabled of updating is as TL;
TL=ceil(1.5 \sqrt{numSeq}), denoting the length of ActionList as nAction, and initializing TL into an nAction-row and one-column array;
wherein, ceil( ) indicates an operation of rounding up to an integer of a result when a floating number is calculated;
Step 53, saving an optimal tabu neighbor operation list selection index in iActionbestTabu, initializing iActionbestTabu=0, initializing an unimproved search counting variableni=0, and initializing the unimproved tabu search upper limit to NI.

Other steps and parameters in this embodiment are the same as those in Specific Embodiments 1-6.

Specific Embodiment 8: This embodiment is different from Specific Embodiments 1-7 in that in Step 6, determining whether the current number of times of unimproved tabu searches is less than the unimproved tabu search upper limit; if so, performing Step 7; otherwise, performing Step 9; specifically:
Step 61, determining whether the unimproved search counting variable ni is less than or equal to NI; if so, performing Step 62; otherwise, performing Step 9;

NI=TL;
wherein, NI indicates the unimproved tabu search upper limit, and TL indicates the number of times of being disabled of updating;
Step 62, initializing the optimal assembly time TotalCostbest Tabu to be infinite inf, and initializing a count variable it in this round to 1;
Step 63, if it is less than TL, performing Step 71; otherwise, performing Step 84.

Other steps and parameters in this embodiment are the same as those in Specific Embodiments 1-7.

Specific Embodiment 9: This embodiment is different form Specific Embodiments 1-8 in that in Step 9, the specific process of performing a neighbor search operation on the heuristic adaptive information link to obtain a current heuristic adaptive information link, invoking the heuristic adaptive information link decoding algorithm to decode the current heuristic adaptive information link to obtain a corresponding placement process optimization result as a candidate solution, and performing Step 8 comprises:
Step 71, setting a tabu flag TCflag=1, and setting a neighbor operation list selection index iAction=ceil(nAction*rand( ), wherein rand( ) indicates the generation of a floating number from 0 to 1;
Step 72, newHSlink=DoAction(HATSlink,ActionList(iAction));
wherein, newHSlink is a new heuristic adaptive information link;
HATSlink indicates the heuristic adaptive information link;
DoAction( ) is an operator identifier corresponding to ActionList(iAction)(1), and corresponding commuting, reversal and interpolation operations are performed on two indexes ActionList(iAction)(2) and ActionList(iAction)(3) of HATSlink to obtain the new heuristic adaptive information link;
ActionList(iAction)(1) indicates the first element in the (iAction)^{th} row of the tabu list, ActionList(iAction)(2) indicates the second element in the (iAction)^{th} row of the tabu list, and ActionList(iAction)(3) indicates the third element in the (iAction)^{th} row of the tabu list;
Step 73, if TC(iAction) is not equal to 0, TCflag=0; otherwise, not changing the value of the tabu flag TCflag;
TC(iAction) indicates the number of times of being disabled of the neighbor operation on the (iAction)^{th} row of the tabu list;
Step 74, because the heuristic adaptive information link HATSlink is a one-row and (4*K+H)-column array formed by splicing the component allocation information link CpAlink and the pick-and-place path information link PAPlink, updating the heuristic adaptive information link according to the new heuristic adaptive information link HATSlink=newHSlink, then splittingHATSlink, using first (3*K+H) columns of HATSlinkto update CpAlink, and using last K columns to update PAPlink;
Step 75, performing Step 41 and Step 42 to decode the component allocation information link CpAlink, and performing component allocation according to a decoding result;
Step 76, performing Step 43, Step 44 and Step 45 to decode the updated pick-and-place path information link PAPlink, obtaining a pick-and-place path according to the decoding result, and then obtaining a candidate solution according to the nozzle assignment result, the component allocation result and the pick-and-place path optimization result;
wherein, the total PCB assembly time TotalCost is calculated as follows:
the total movement distance total_disof head assembly is obtained according to the pick-and-place path optimization result, and the total PCBassembly time TotalCost=total_dis/vis calculated based on total movement distance total_dis and an average movement speed v of head assembly;
the final objective is a minimum time, including a minimum nozzle replacement time, a minimum equivalent pickup time, and a minimum movement time (equivalent to a shortest path).

The nozzle assignment optimizes the number of nozzle replacements (the nozzle replacement time) and constrains subsequent component allocation.

The component allocation optimizes the number of simultaneous pickups (equivalent pickup time) and constrains pick-and-place path optimization.
The pick-and-place path optimization further optimizes the path length, which is determined by results of three problems.

Other steps and parameters in this embodiment are the same as those in Specific Embodiments 1-8.

Specific Embodiment 10: This embodiment is different from Specific Embodiments 1-9 in that in Step 8, the specific process of updating a current solution according to the candidate solution and tabu list, updating the tabu list, and returning to Step 6 comprises:
Step 81, if the total PCB assembly time TotalCost obtained by performing Step 67 is less than the optimal total assembly time TotalCostbest, updating the current solution:
updating the optimal total assembly time TotalCostbest=TotalCost
updating the optimal heuristic adaptive information link HATSlinkbest=newHSlink
wherein, newHSlink is a new heuristic adaptive information link;
updating an optimal neighbor operation list selection index iActionbest=iAction
wherein iAction is the neighbor operation list selection index;
otherwise, not updating the current solution;
Step 82, if TCflag=1 and TotalCost is less than TotalCostbestTabu, updating the tabu list:
updating the optimal total assembly time in the tabu list TotalCostbestTabu=TotalCost
updating the optimal heuristic adaptive information link HATSlinkbestTabu=newHSlink
updating an optimal tabu neighbor operation list selection index iActionbestTabu=iAction
otherwise, not updating the tabu list;
Step 83, it=it+1, returning to Step 63;
Step 84, ni=ni+1;
Step 85, updating the tabu list and the heuristic information link specifically as follows:
Step 851, if TotalCostbest is less than TotalCost, performing Step 825; otherwise, performing Step 855;
Step 852, updating the heuristic information link and the total PCBassembly time HATSlink=HATSlinkbest, TotalCost=TotalCostbest;
Step 853, updating the tabu list specifically as follows:
Step 8531, defining a loop variable i=1;
Step 8532, if i is less than nAction, performing Step 8533; otherwise, returning to Step 854;
Step 8533, if i is equal to iActionbest, TC(i)=TL; otherwise, TC(i)=max (TC(i)−1,0);
wherein, TC(i) indicates the number of times of being disabled of the neighbor operation on the i^{th} row in the neighbor operation list; and
Step 8644, i=i+1, returning to Step 8532;
Step 854, ni=0;
Step 855, updating the heuristic adaptive information link HATSlink=HATSlinkbestTabu; and
Step 856, updating the tabu list specifically as follows:
Step 8561, defining a loop variable i=1;
Step 8562, if i is less than nAction, performing
Step 8563; otherwise, performing Step 86;
Step 8563, if i is equal to iActionbest, TC(i)=TL; otherwise, TC(i)=max (TC(i)−1,0);
Step 8564, i=i+1, returning to Step 8562;
Step 86, returning to Step 6.

Other steps and parameters in this embodiment are the same as those in Specific Embodiments 1-9.

The beneficial effects of the invention are verified with reference to the following exemplary application.

### Exemplary Application 1

The method for optimizing the placement process of surface mounters based on heuristic adaptive search is specifically implemented according to the following steps.

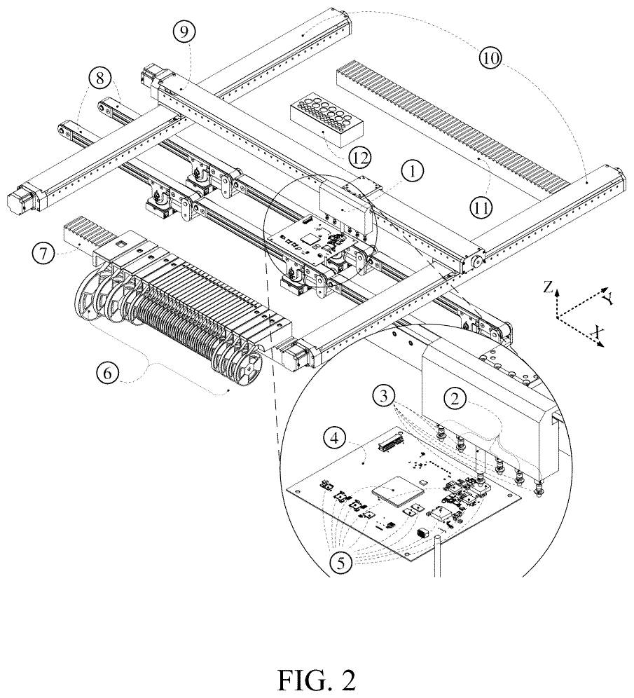

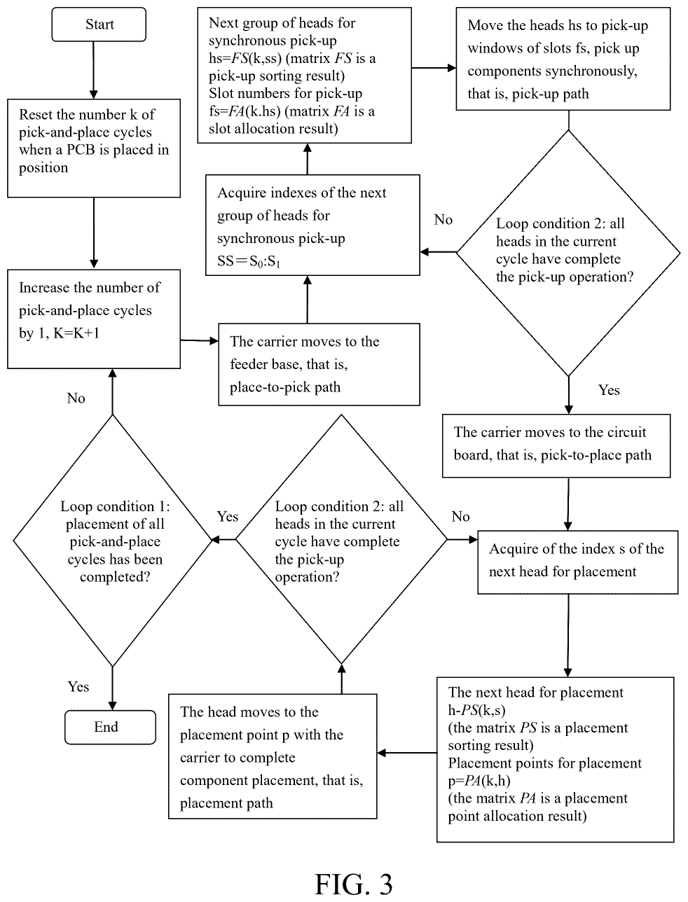

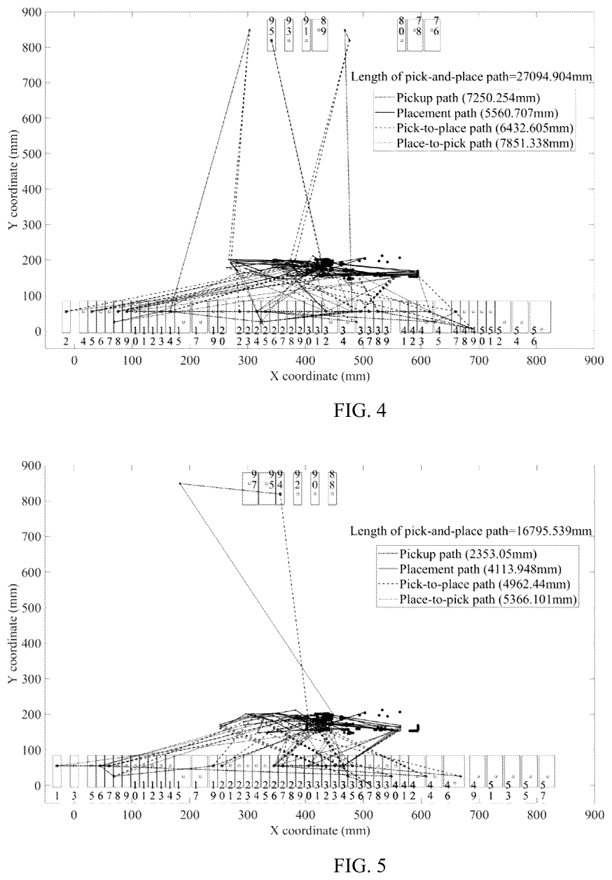

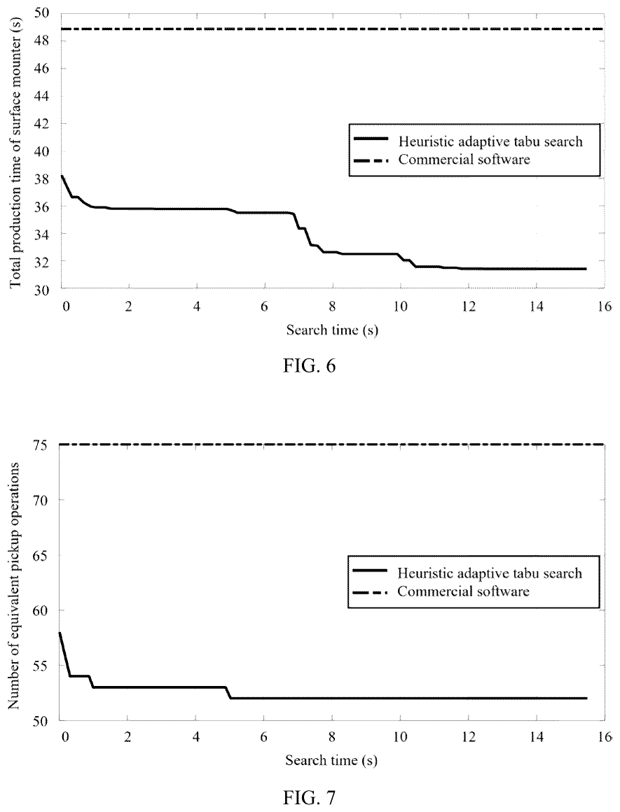

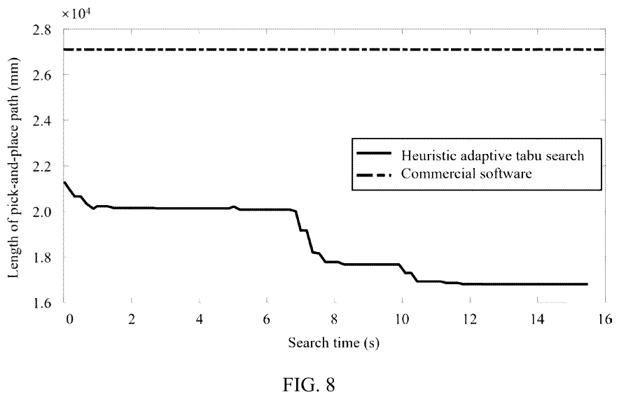

In this exemplary application, the placement process of a six-head surface mounter shown in FIG. 2 is optimized.

PCB production data to be imported are shown in Table 1, including 51 types of components and 125 placement points.

TABLE 1
PCB production data

| Serial | | X- | Y- |
|---|---|---|---|
| number of | Type of | coordinate | coordinate |
| components | components | (mm) | (mm) |
| 1 | C28 | 125.0 | 15.9 |
| 2 | C11 | 134.0 | 18.0 |
| 3 | C11 | 126.5 | 15.9 |
| 4 | C12 | 137.2 | 21.2 |
| 5 | C12 | 136.0 | 15.5 |
| 6 | C13 | 135.6 | 18.0 |
| 7 | C13 | 128.1 | 16.0 |
| 8 | C14 | 135.6 | 20.3 |
| 9 | C14 | 134.3 | 14.8 |
| 10 | C15 | 137.2 | 18.0 |
| 11 | C15 | 137.8 | 15.7 |
| 12 | C29 | 125.7 | 18.6 |
| 13 | C7 | 44.9 | 58.2 |
| 14 | C7 | 44.3 | 46.3 |
| 15 | C7 | 42.5 | 46.3 |
| 16 | C7 | 45.0 | 56.6 |
| 17 | C8 | 47.4 | 57.4 |
| 18 | C8 | 50.8 | 57.4 |
| 19 | C8 | 49.4 | 46.3 |
| 20 | C8 | 46.0 | 46.3 |
| 21 | C16 | 30.7 | 14.2 |
| 22 | C16 | 30.7 | 15.9 |
| 23 | C30 | 23.4 | 41.0 |
| 24 | C3 | 66.2 | 52.5 |
| 25 | C3 | 50.9 | 53.3 |
| 26 | C3 | 50.8 | 49.7 |
| 27 | C3 | 66.4 | 47.6 |
| 28 | C3 | 40.3 | 51.2 |
| 29 | C3 | 37.2 | 16.9 |
| 30 | C3 | 82.9 | 9.2 |
| 31 | C6 | 47.7 | 46.3 |
| 32 | C6 | 51.1 | 46.4 |
| 33 | C6 | 49.1 | 57.4 |
| 34 | C6 | 52.5 | 57.4 |
| 35 | C6 | 35.0 | 14.0 |
| 36 | C17 | 34.7 | 17.2 |
| 37 | C17 | 33.2 | 14.0 |
| 38 | C18 | 48.8 | 53.5 |
| 39 | C18 | 48.7 | 49.7 |
| 40 | C31 | 52.5 | 32.5 |
| 41 | C32 | 72.2 | 29.0 |
| 42 | C33 | 36.6 | 47.5 |
| 43 | C34 | 72.2 | 31.4 |
| 44 | C35 | 168.6 | 66.3 |
| 45 | C36 | 32.3 | 44.8 |
| 46 | C37 | 40.2 | 48.4 |
| 47 | C4 | 37.7 | 43.2 |
| 48 | C4 | 39.7 | 38.9 |
| 49 | C4 | 46.0 | 61.2 |
| 50 | C4 | 39.5 | 53.9 |
| 51 | C4 | 43.2 | 62.2 |
| 52 | C4 | 39.5 | 62.2 |
| 53 | C19 | 67.5 | 45.0 |
| 54 | C19 | 82.8 | 5.6 |
| 55 | C2 | 191.0 | 13.1 |
| 56 | C2 | 200.0 | 19.1 |
| 57 | C2 | 188.3 | 13.1 |
| 58 | C2 | 195.9 | 13.1 |
| 59 | C2 | 199.8 | 28.6 |
| 60 | C2 | 198.6 | 12.5 |
| 61 | C2 | 200.0 | 21.8 |
| 62 | C2 | 200.0 | 16.5 |
| 63 | C2 | 200.0 | 24.5 |
| 64 | C2 | 193.5 | 13.1 |
| 65 | C2 | 185.6 | 13.1 |
| 66 | C2 | 96.4 | 18.6 |
| 67 | C2 | 93.7 | 18.6 |
| 68 | C1 | 34.5 | 36.0 |
| 69 | C1 | 31.7 | 36.0 |
| 70 | C1 | 29.0 | 36.0 |
| 71 | C1 | 25.7 | 45.5 |
| 72 | C1 | 23.0 | 45.5 |
| 73 | C1 | 28.4 | 45.5 |
| 74 | C1 | 68.4 | 53.0 |
| 75 | C1 | 71.3 | 48.2 |
| 76 | C1 | 37.1 | 36.1 |
| 77 | C1 | 40.1 | 60.0 |
| 78 | C1 | 43.1 | 53.7 |
| 79 | C1 | 83.2 | 31.1 |
| 80 | C1 | 87.5 | 32.3 |
| 81 | C1 | 80.0 | 31.1 |
| 82 | C1 | 41.1 | 34.4 |
| 83 | C1 | 40.8 | 31.6 |
| 84 | C38 | 73.8 | 16.5 |
| 85 | C39 | 18.5 | 38.0 |
| 86 | C40 | 35.6 | 43.8 |
| 87 | C41 | 36.4 | 40.0 |
| 88 | C42 | 31.1 | 40.0 |
| 89 | C43 | 35.5 | 31.9 |
| 90 | C20 | 44.9 | 49.5 |
| 91 | C20 | 38.5 | 19.0 |
| 92 | C44 | 35.9 | 55.1 |
| 93 | C45 | 79.2 | 5.0 |
| 94 | C21 | 80.3 | 9.1 |
| 95 | C21 | 76.0 | 34.2 |
| 96 | C22 | 79.3 | 16.6 |
| 97 | C22 | 98.5 | 18.6 |
| 98 | C23 | 68.5 | 16.5 |
| 99 | C23 | 71.2 | 16.5 |
| 100 | C24 | 25.0 | 35.5 |
| 101 | C24 | 76.7 | 27.4 |
| 102 | C46 | 34.8 | 51.2 |
| 103 | C47 | 130.6 | 22.7 |
| 104 | C48 | 76.6 | 17.1 |
| 105 | C49 | 50.9 | 36.3 |
| 106 | C9 | 7.7 | 31.4 |
| 107 | C9 | 7.7 | 25.6 |
| 108 | C9 | 7.6 | 19.8 |
| 109 | C5 | 31.2 | 60.7 |
| 110 | C5 | 26.0 | 50.1 |
| 111 | C5 | 27.0 | 60.8 |
| 112 | C5 | 26.0 | 54.1 |
| 113 | C5 | 22.8 | 60.9 |
| 114 | C5 | 35.4 | 60.9 |
| 115 | C25 | 143.0 | 16.8 |
| 116 | C25 | 143.0 | 20.8 |
| 117 | C26 | 154.6 | 15.8 |
| 118 | C26 | 48.8 | 29.7 |
| 119 | C27 | 98.9 | 57.4 |
| 120 | C27 | 108.0 | 63.5 |
| 121 | C50 | 87.6 | 7.1 |
| 122 | C51 | 72.6 | 8.1 |
| 123 | C10 | 132.7 | 56.8 |
| 124 | C10 | 138.0 | 71.9 |
| 125 | C10 | 147.3 | 54.2 |

Types of nozzles for picking components and types of feeders for feeding components are shown in Table 2, and four types of nozzles and four types of feeders are needed.

TABLE 2
Component information table

| Serial | | |
|---|---|---|
| number of | Type of | X-coordinate |
| components | components | (mm) |
| C1 | N1 | SM8 |
| C2 | N1 | SM8 |
| C3 | N1 | SM8 |
| C4 | N2 | SM8 |
| C5 | N4 | SM12 |
| C6 | N1 | SM8 |
| C7 | N1 | SM8 |
| C8 | N1 | SM8 |
| C9 | N3 | SM12 |
| C10 | N3 | SM24 |
| C11 | N2 | SM8 |
| C12 | N2 | SM8 |
| C13 | N2 | SM8 |
| C14 | N2 | SM8 |
| C15 | N2 | SM8 |
| C16 | N1 | SM8 |
| C17 | N1 | SM8 |
| C18 | N1 | SM8 |
| C19 | N2 | SM8 |
| C20 | N1 | SM8 |
| C21 | N1 | SM8 |
| C22 | N1 | SM8 |
| C23 | N1 | SM8 |
| C24 | N1 | SM8 |
| C25 | N4 | SM12 |
| C26 | N3 | SM12 |
| C27 | N3 | SM12 |
| C28 | N2 | SM8 |
| C29 | N1 | SM8 |
| C30 | N1 | SM8 |
| C31 | N1 | SM8 |
| C32 | N1 | SM8 |
| C33 | N1 | SM8 |
| C34 | N1 | SM8 |
| C35 | N1 | SM8 |
| C36 | N1 | SM8 |
| C37 | N1 | SM8 |
| C38 | N1 | SM8 |
| C39 | N4 | SM8 |
| C40 | N1 | SM8 |
| C41 | N1 | SM8 |
| C42 | N1 | SM8 |
| C43 | N1 | SM8 |
| C44 | N1 | SM8 |
| C45 | N1 | SM8 |
| C46 | N4 | SM12 |
| C47 | N3 | SM12 |
| C48 | N4 | SM12 |
| C49 | N4 | SM12 |
| C50 | N3 | SM12 |
| C51 | N3 | SM16 |

Before the invention is implemented, an initial nozzle assignment result NZg is obtained according to the nozzle assignment method provided by Patent No. 201810829630.8:

$$NZg = [ \begin{matrix}1 & 1 & 1 & 2 & 3 & 4 \\ 1 & 1 & 1 & 2 & 3 & 0 \\ 1 & 1 & 1 & 2 & 0 & 0 \\ 1 & 1 & 1 & 0 & 0 & 0\end{matrix} ]$$

wherein, the number of pick-and-place cycles in each nozzle row is numKinNzl=[12 1 6 8], that is, there are sum(numKinNzl)=27 pick-and-place cycles in total in each nozzle row.

Based on the initial nozzle assignment result NZg, a complete placement optimization result of the surface mounter is obtained by means of the heuristic adaptive tabu search method provided by the invention. A heuristic adaptive information link obtained by optimization is HATSlink=[10018 30002 30003 30004 30005 30006 30007 17 30016 30013 30015 30012 10037 30017 30025 30009 30008 30010 24 30018 30020 30021 30023 27 20001 30026 30027 25 30024 20002 20003 20004 20006 10004 10005 10003 10001 30019 10008 10045 10002 6 10023 10034 26 10025 10026 10029 10039 19 10038 30011 10036 10035 10051 10032 10031 10030 21 30001 10 30022 10015 10053 10054 10017 30014 10027 15 10044 1 10028 13 20 10013 16 4 9 10006 10007 10014 10047 2 10046 5 7 8 10042 10012 10052 10049 10048 10011 10010 10019 10020 10022 10009 10021 10040 10050 10033 10043 14 18 11 22 3 10041 23 12 10024 10016 20005].

A component allocation information link CpAlink included in the heuristic adaptive information link HATSlink is:

CpAlink=[10018 30002 30003 30004 30005 30006 30007 30016 30013 30015 30012 10037 30017 30025 30009 30008 30010 30018 30020 30021 30023 20001 30026 30027 30024 20002 20003 20004 20006 10004 10005 10003 10001 30019 10008 10045 10002 10023 10034 10025 10026 10029 10039 10038 30011 10036 10035 10051 10032 10031 10030 30001 30022 10015 10053 10054 10017 30014 10027 10044 10028 10013 10006 10007 10014 10047 10046 10042 10012 10052 10049 10048 10011 10010 10019 10020 10022 10009 10021 10040 10050 10033 10043 10041 10024 10016 20005].

A sequence SeqNzl for performing component allocation on the nozzle rows is extracted from the component allocation information link CpAlink:
SeqNzl=[1 1 1 1 1 1 3 2 3 1 3 4 1 1 1 3 4 4 4 4 4 4 3 1 1 4 3].

A head sequence SeqHd for component allocation is extracted from the component allocation information link CpAlink:
SeqHd=[1 2 3 4 6 5].

A component allocation algorithm selection link Seq01link is extracted from the component allocation information link CpAlink:

Seq01link=[18 37 4 5 3 1 8 45 2 23 34 25 26 29 39 38 36 35 51 32 31 30 15 53 54 17 27].

An algorithm selection binary array Seq01Bincorresponding to the 27 pick-and-place cycles is:

Seq01Bin=[1 1 1 1 1 1 1 1 1 1 1 1 1 1 1 1 1 1 1 1 1 1 1 1 1 1 1 0 0 0 0 0 0 0 0 0 0 0 0 0 0 0 0 0 0 0 0 0 0 0 0 0 0 0].

A component allocation algorithm selection information link SeqCpAa is obtained according to Seq01Bin and Seq01link:

SeqCpAa=Seq01Bin (Seq01link)=[1 0 1 1 1 1 1 0 1 1 0 1 1 0 0 0 0 0 0 0 0 0 1 0 0 1 1].

Component allocation is performed based on SeqNzl, SeqHd and SeqCpAa to obtain a component allocation result CPg and a feeder grouping result fs. Wherein, the component allocation result CPg is:

$$CPg = [ \begin{matrix}1 & 2 & 3 & 4 & 5 & 9 \\ 1 & 2 & 3 & 4 & 5 & 10 \\ 6 & 7 & 8 & 11 & 25 & 26 \\ 16 & 17 & 18 & 12 & 39 & 27 \\ 20 & 21 & 22 & 13 & 46 & 27 \\ 23 & 24 & 29 & 14 & 48 & 47 \\ 36 & 37 & 38 & 28 & 49 & 51 \\ 16 & 17 & 18 & 12 & 0 & 50 \\ 30 & 31 & 32 & 15 & 0 & 0 \\ 33 & 34 & 35 & 19 & 0 & 0 \\ 20 & 21 & 22 & 13 & 0 & 0 \\ 1 & 2 & 3 & 14 & 0 & 0 \\ 43 & 44 & 45 & 15 & 0 & 0 \\ 6 & 23 & 24 & 19 & 0 & 0 \\ 40 & 41 & 42 & 0 & 0 & 0 \\ 6 & 7 & 8 & 0 & 0 & 0 \\ 1 & 2 & 2 & 0 & 0 & 0 \\ 1 & 2 & 1 & 0 & 0 & 0\end{matrix} ]$$

wherein, the number of pick-and-place cycles in each sub-cycle is numKinCpl=[3321 1 1 1 1 1 1 1 1 1 1 1 21 4].

There are 17 feeder groups in total, which are respectively fs{1}=[1 2 3 4], fs{2}=[5 9], fs{3}=[10], fs{4}=[6 7 8 11], fs{5}=[25 26], fs{6}=[16 17 18 12 39], fs{7}=[46 27], fs{8}=[20 21 22 13], fs{9}=[23 24 29 14], fs{10}=[48 47], fs{11}=[30 31 32 15], fs{12}=[50], fs{13}=[33 34 35 19], fs{14}=[36 37 38 28], fs{15}=[49 51], fs{16}=[40 41 42], and fs{17}=[43 44 45].

A pick-and-place path optimization sequence information link PAPlink included in the heuristic adaptive information link HATSlink is: PAPlink=[17 24 27 25 6 26 19 21 10 15 1 13 20 16 4 9 2 5 7 8 14 18 11 22 3 23 12].

Based on PAPlink, a sequence SeqCPl for performing pick-and-place path optimization on the sub-cycles is:

SeqCPl=[12 18 2 14 16 5 10 1 8 15 11 4 3 9 13 6 17 7].

All the sub-cycles are looped through in the sequence, and the heuristic algorithm in Literature (H. Gao, Z. Li, X. Yu and J. Qiu, “Hierarchical multiobjective heuristic for PCB assembly optimization in a beam-head surface mounter,” IEEE Trans. Cybern., vol. 52, no. 7, pp. 6911-6924 July 2022.) is used for perform pick-and-place path optimization. In this way, a placement point allocation result PA, a placement sorting result PS, and a slot allocation result FS of the feeder groups are obtained.

The obtained placement point allocation result PA and placement sorting result PS are:

$$PA = [ \begin{matrix}77 & 59 & 26 & 52 & 112 & 106 \\ 82 & 63 & 28 & 50 & 110 & 107 \\ 78 & 61 & 29 & 47 & 113 & 108 \\ 83 & 64 & 30 & 49 & 114 & 125 \\ 68 & 58 & 24 & 51 & 109 & 124 \\ 76 & 60 & 25 & 48 & 111 & 123 \\ 32 & 14 & 17 & 2 & 116 & 117 \\ 34 & 15 & 20 & 3 & 115 & 118 \\ 21 & 37 & 38 & 4 & 85 & 119 \\ 91 & 94 & 97 & 7 & 102 & 120 \\ 99 & 100 & 12 & 9 & 104 & 103 \\ 45 & 46 & 84 & 1 & 105 & 122 \\ 22 & 36 & 39 & 5 & 0 & 121 \\ 23 & 40 & 41 & 10 & 0 & 0 \\ 42 & 43 & 44 & 53 & 0 & 0 \\ 90 & 95 & 96 & 6 & 0 & 0 \\ 72 & 67 & 27 & 8 & 0 & 0 \\ 89 & 92 & 93 & 11 & 0 & 0 \\ 35 & 98 & 101 & 54 & 0 & 0 \\ 86 & 87 & 88 & 0 & 0 & 0 \\ 31 & 16 & 18 & 0 & 0 & 0 \\ 33 & 13 & 19 & 0 & 0 & 0 \\ 74 & 62 & 56 & 0 & 0 & 0 \\ 71 & 66 & 80 & 0 & 0 & 0 \\ 73 & 65 & 79 & 0 & 0 & 0 \\ 70 & 57 & 81 & 0 & 0 & 0 \\ 69 & 55 & 75 & 0 & 0 & 0\end{matrix} ]$$

$$PS = [ \begin{matrix}6 & 5 & 4 & 3 & 1 & 2 \\ 6 & 5 & 4 & 3 & 1 & 2 \\ 6 & 5 & 4 & 3 & 1 & 2 \\ 5 & 5 & 6 & 3 & 1 & 2 \\ 5 & 4 & 6 & 3 & 1 & 2 \\ 5 & 4 & 6 & 3 & 1 & 2 \\ 4 & 1 & 2 & 3 & 5 & 6 \\ 4 & 5 & 1 & 2 & 3 & 6 \\ 5 & 6 & 2 & 1 & 4 & 3 \\ 5 & 6 & 1 & 2 & 3 & 4 \\ 5 & 6 & 2 & 4 & 3 & 1 \\ 2 & 1 & 4 & 3 & 6 & 5 \\ 6 & 2 & 1 & 4 & 3 & 0 \\ 1 & 4 & 2 & 3 & 0 & 0 \\ 4 & 1 & 2 & 3 & 0 & 0 \\ 3 & 4 & 2 & 1 & 0 & 0 \\ 3 & 1 & 4 & 2 & 0 & 0 \\ 2 & 1 & 4 & 3 & 0 & 0 \\ 2 & 1 & 3 & 4 & 0 & 0 \\ 3 & 2 & 1 & 0 & 0 & 0 \\ 1 & 2 & 3 & 0 & 0 & 0 \\ 1 & 2 & 3 & 0 & 0 & 0 \\ 2 & 3 & 1 & 0 & 0 & 0 \\ 3 & 1 & 2 & 0 & 0 & 0 \\ 3 & 1 & 2 & 0 & 0 & 0 \\ 3 & 1 & 2 & 0 & 0 & 0 \\ 3 & 1 & 2 & 0 & 0 & 0\end{matrix} ]$$

The slot allocation result FS of the feeder groups is FS=[34 42 46 26 51 6 15 19 35 55 7 49 27 94 97 20 1], and a pickup slot allocation result FA and a pickup sorting result FP in each sub-cycle are:

$$FA = [ \begin{matrix}34 & 36 & 38 & 40 & 42 & 44 \\ 32 & 36 & 38 & 40 & 42 & 46 \\ 26 & 28 & 30 & 32 & 51 & 53 \\ 6 & 8 & 10 & 12 & 14 & 17 \\ 19 & 21 & 23 & 25 & 15 & 17 \\ 35 & 37 & 39 & 41 & 55 & 57 \\ 94 & 92 & 90 & 88 & 97 & 95 \\ 6 & 8 & 10 & 12 & 0 & 49 \\ 7 & 9 & 11 & 13 & 0 & 0 \\ 27 & 29 & 31 & 33 & 0 & 0 \\ 19 & 21 & 23 & 25 & 0 & 0 \\ 34 & 36 & 38 & 41 & 0 & 0 \\ 1 & 3 & 5 & 13 & 0 & 0 \\ 26 & 35 & 37 & 33 & 0 & 0 \\ 20 & 22 & 24 & 0 & 0 & 0 \\ 26 & 28 & 30 & 0 & 0 & 0 \\ 34 & 36 & 36 & 0 & 0 & 0 \\ 34 & 36 & 34 & 0 & 0 & 0\end{matrix} ]$$

$$FP = [ \begin{matrix}3 & 4 & 1 & 2 & 5 & 6 \\ 3 & 4 & 1 & 2 & 5 & 6 \\ 1 & 2 & 3 & 4 & 5 & 6 \\ 1 & 2 & 3 & 4 & 5 & 6 \\ 5 & 6 & 1 & 2 & 3 & 4 \\ 3 & 4 & 1 & 2 & 5 & 6 \\ 5 & 6 & 1 & 2 & 3 & 4 \\ 1 & 2 & 3 & 4 & 6 & 5 \\ 1 & 2 & 3 & 4 & 5 & 6 \\ 1 & 2 & 3 & 4 & 5 & 6 \\ 1 & 2 & 3 & 4 & 5 & 6 \\ 3 & 1 & 2 & 4 & 5 & 6 \\ 1 & 2 & 3 & 4 & 5 & 6 \\ 1 & 4 & 2 & 4 & 5 & 6 \\ 1 & 2 & 3 & 4 & 5 & 6 \\ 1 & 2 & 3 & 4 & 5 & 6 \\ 3 & 1 & 2 & 4 & 5 & 6 \\ 3 & 1 & 2 & 4 & 5 & 6\end{matrix} ]$$

According to placement optimization results obtained by existing commercial software (based on the approach for head task assignment for a single-gantry parallel-head surface mounter provided by US201810829630.8), the number of simultaneous pickups is 50, the number of equivalent pickup operations is 75, the length of the pick-and-place path is 27094.9 mm, the total production time of the surface mounter is Tc=48.9 s, and the pick-and-place path is shown in FIG. 4. According to placement optimization results obtained by the method provided by the invention, the number of simultaneous pickups is 73, the number of equivalent pickup operations is 52, the length of the pick-and-place path is 16795.5 mm, the total production time of the surface mounter is Tc=31.4 s, the convergence process of the total production time of the surface mounter is shown in FIG. 6, the convergence process of the number of simultaneous pickups is shown in FIG. 7, and the convergence process of the length of the pick-and-place path is shown in FIG. 8. In this exemplary application, the total production time of the surface mounter can be shortened by 100%*(Tb−Tc)/Tc=35.79%.

The invention may have many other embodiments. Those skilled in the art can make various corresponding modifications and transformations according to the invention without departing from the spirit and principle of the invention, and all these modifications and transformations should also fall within the protection scope of the appended claims of the invention.

What is claimed is:

1. A method for optimizing the placement process of surface mounters based on heuristic adaptive tabu search, comprising:
invoking a heuristic adaptive information link encoding algorithm to encode a component allocation problem and a pick-and-place path optimization problem to obtain encoded information that comprises a sequence of component allocation of nozzle rows, a head sequence in a component allocation result, a selected component allocation heuristic algorithm, and a sequence of pick-and-place path optimization of sub-cycles;
invoking a heuristic adaptive information link decoding algorithm to decode the encoded information, configuring the component allocation heuristic algorithm and a pick-and-place path optimization heuristic algorithm according to a decoding result, and obtaining a placement process optimization result using the configured heuristic algorithms, the component allocation heuristic algorithm being an available feeder-oriented heuristic algorithm or an assigned feeder group-oriented heuristic algorithm, and the available feeder-oriented heuristic algorithm and the assigned feeder group-oriented heuristic algorithm providing a best optimization result respectively in a production scenario where the number of feeders is sufficient and a production scenario where the number of feeders is limited; and
determining whether a current number of unimproved searches is less than an unimproved tabu search upper limit; if so, performing a neighbor search operation on a heuristic adaptive information link to obtain a current heuristic adaptive information link, invoking the heuristic adaptive information link decoding algorithm to decode a current heuristic adaptive information link to obtain a corresponding placement process optimization result as a candidate solution, updating a current solution according to the candidate solution and a tabu list, updating the tabu list, and determining whether the current number of unimproved searches is less than the unimproved tabu search upper limit again; if not, outputting a current placement process optimal result obtained by searching; and performing SMT production, by a surface mounter, according to a component allocation result, a placement point allocation result, a placement sorting result, and a pickup slot allocation result FA and a pickup sorting result FP in each sub-cycle output by the algorithm.

2. The method for optimizing the placement process of surface mounters based on heuristic adaptive tabu search according to claim 1, wherein a specific process of invoking a heuristic adaptive information link encoding algorithm to encode a component allocation problem and a pick-and-place path optimization problem to obtain encoded information that comprises a sequence of component allocation of nozzle rows, a head sequence in a component allocation result, a selected component allocation heuristic algorithm, and a sequence of pick-and-place path optimization of sub-cycles comprises:
Step 1, acquiring parameters of the surface mounter and PCB production data;
Step 2, obtaining a nozzle assignment result based on a nozzle assignment heuristic algorithm; and
Step 3, initializing a heuristic adaptive information link;
a specific process of invoking a heuristic adaptive information link decoding algorithm to decode the encoded information, configuring the component allocation heuristic algorithm and a pick-and-place path optimization heuristic algorithm according to a decoding result, and obtaining a placement process optimization result using the configured heuristic algorithms, the component allocation heuristic algorithm being an available feeder-oriented heuristic algorithm or an assigned feeder group-oriented heuristic algorithm, and the available feeder-oriented heuristic algorithm and the assigned feeder group-oriented heuristic algorithm providing a best optimization result respectively in a production scenario where the number of feeders is sufficient and a production scenario where the number of feeders is limited comprises:
Step 4, decoding a component allocation information link CpAlink;
executing a component allocation algorithm according to a component allocation information link decoding result to complete component allocation to obtain a component allocation result Cpg;
performing path optimization in all pick-and-place cycles according to PAPlink, and updating a pick-and-place path optimization result;
calculating a corresponding total PCB assembly time TotalCost according to the nozzle assignment result, the component allocation result, and the pick-and-place path optimization result; and
initializing an optimal total assembly time TotalCostbest=TotalCost, and then outputting a placement process optimal result;
wherein, in the production scenario where the number of feeders is sufficient, the number of feeders corresponding to each type of components is greater than the number of heads corresponding to said type of components; in the production scenario where the number of feeders is limited, there is only one available feeder for each type of components;
a specific process of determining whether a current number of unimproved searches is less than an unimproved tabu search upper limit; if so, performing a neighbor search operation on a heuristic adaptive information link to obtain a current heuristic adaptive information link, invoking the heuristic adaptive information link decoding algorithm to decode a current heuristic adaptive information link to obtain a corresponding placement process optimization result as a candidate solution, updating a current solution according to the candidate solution and a tabu list, updating the tabu list, and determining whether the current number of unimproved searches is less than the unimproved tabu search upper limit again; if not, outputting a current placement process optimal result obtained by searching; and performing SMT production, by a surface mounter, according to a component allocation result, a placement point allocation result, a placement sorting result, and a pickup slot allocation result FA and a pickup sorting result FP in each sub-cycle output by the algorithm comprises:
Step 5, initializing tabu search parameters, initializing the tabu list, and determining a tabu length and the unimproved tabu search upper limit;
Step 6, determining whether a current number of unimproved tabu searches is less than the unimproved tabu search upper limit; if so, performing Step 7; otherwise, performing Step 9;
Step 7, performing a neighbor search operation on the heuristic adaptive information link to obtain the current heuristic adaptive information link, invoking the heuristic adaptive information link decoding algorithm to decode the current heuristic adaptive information link to obtain the corresponding placement process optimization result as the candidate solution, and performing Step 8;
Step 8, updating the current solution according to the candidate solution and the tabu list, updating the tabu list, and returning to Step 6; and
Step 9, outputting the current placement process optimal result obtained by searching, which specifically comprises:
performing SMT production by the surface mounter according to the component allocation result Cpg, the placement point allocation result PA, the placement sorting result PS, and the pickup slot allocation result FA and the pickup sequence result FP in each sub-cycle output by the algorithm.

3. The method for optimizing the placement process of surface mounters based on heuristic adaptive tabu search according to claim 2, wherein the parameters of the surface mounter and the PCB production data are acquired specifically as follows:
components with a same component type name are a same type of components, types of components in a data file of a PCB to be assembled are counted to obtain a total number C of the types of components, the types of components are numbered as c∈{1,2, . . . ,C} according to an sequence in which the types of components appear in the data file of the PCB, the numbers of the types of components are called component numbers, and the number of placement points corresponding to one type of components is called the number of placement points corresponding to the component number; the number of placement points corresponding to the type of components refers to the number of all placement points corresponding to components of this type on the PCB;
types of nozzles used for producing the PCB are obtained according to the data file of the PCB and a component information file, and the types of nozzles are numbered as n∈[1, . . . ,N] in a decreasing order according to the number of placement points corresponding to the types of nozzles, wherein N is a total number of the types of nozzles, numbers of the nozzles are called nozzle number; the number of placement points corresponding to each type of nozzles is saved in Pn, wherein Pn indicates the number of placement points corresponding to the nozzle number n;
a maximum number of each type of available nozzles is set and saved in linNz, wherein linNz (n) indicates the number of available nozzles corresponding to the nozzle number n;
a total number of heads of the surface mounter is set as H, and indexes of the heads are numbered as h∈[1, . . . ,H] in an increasing order along an X-axis;
a total number of placement points is set as Q, and indexes of the placement points are numbered as q∈[1, . . . ,Q];
a total number of the pick-and-place cycles is set as K, and indexes of the pick-and-place cycles are numbered as k∈[1, . . . ,K];
a K-row and H-column two-dimensional array PS, all elements of which are 0, is initialized to be used for saving a placement sorting result, wherein an element PS(k,s) of PS indicates an s^{th} head for placement in a k^{th} pick-and-place cycle, PS(k,s)∈[1, . . . ,H];
the component allocation result is saved in a K-row and H-column two-dimensional array PA, wherein an element PA(k,h) of PA indicates the type of the component picked up and placed by the h^{th} head in the k^{th} pick-and-place cycle, PA(k,h)∈[1, . . . ,C];
indexes of types of feeders are numbered as f∈{1,2, . . . ,F}, wherein F is a total number of types of feeders;
a slot allocation result of feeder groups is saved in a one-dimensional array PS, a pickup slot allocation result in each sub-cycle is saved in FA, and a pickup sorting result is saved in FP, wherein FA and FP are both K-row and H-column two-dimensional arrays;
component numbers corresponding to each type of components are saved in pcb_cp_type_cp_lib_index;
feeder numbers corresponding to each type of components are saved in pcb_cp_type_fd_lib_index;
nozzle numbers corresponding to each type of components are saved in pcb_cp_type_nz_lib_index;
wherein, pcb_cp_type_cp_lib_index, pcb_cp_type_fd_lib_index and pcb_cp_type_nz_lib_index are all one-row and C-column arrays.

4. The method for optimizing the placement process of surface mounters based on heuristic adaptive tabu search according to claim 3, wherein in Step 2, the nozzle assignment result is obtained based on the nozzle assignment heuristic algorithm specifically as follows:
the nozzle assignment result is saved in a numNZl-row and H-column array NZg, which is formed by a series of nozzle combination results and has numNZl nozzle row, wherein the “nozzle row” refers to one nozzle combination result, and in the first nozzle row NZg(1,:)=[1 1 1 2 3 4], 1, 2, 3 and 4 are both nozzle numbers and indicate that nozzles 1 are mounted on heads 1, 2 and 3, nozzle 2 is mounted on head 4, nozzle 3 is mounted on head 5, and nozzle 4 is mounted on head 6;
“:” indicates that all values in a dimension are obtained by auto-increment, and NZg(k,:) indicates the acquisition of all elements in a k^{th} placement sorting chromosome; specifically:
“1:1:H” indicates the acquisition of an array from 1 to H with an increment 1, that is, [1, . . . ,H]; “H:−1:1” indicates the acquisition of an array from H to 1 with an increment −1, that is [H,H−1, . . . , 1],1:1:H is abbreviated as NZg(k,1:H); when the array is indexed, if the first value is 1, the last value will be exactly the number of elements in the dimension, so NZg(k,1:H) is further abbreviated as NZg(k,:);
floorNzCyc is a one-row and numNZl-column array, and each element in floorNzCyc indicates the serial number of the first pick-and-place cycle in one nozzle row;
numKinNZ1 is a one-column and numNZl-column array, and each element in numKinNZ1 indicates the number of all pick-and-place cycles in one nozzle row.

5. The method for optimizing the placement process of surface mounters based on heuristic adaptive tabu search according to claim 4, wherein in Step 3, the heuristic adaptive information link is initialized specifically by the following steps:
Step 31, initializing and assigning nozzle rows to obtain a sequence array SeqNzl=1:K for component allocation, wherein elements in the sequence array indicate component allocation sequences in the pick-and-place cycles; if SeqNzl(5) is 7, it indicates that component allocation will be performed for the nozzle row corresponding to the seventh pick-and-place cycle in the fifth round;
a component allocation algorithm selection information link SeqCpAa is a one-row and K-column array, and elements in SeqCpAa indicate types of component allocation algorithms adopted when component allocation is performed for the nozzle rows; if the element is 1, an available feeder-oriented component allocation algorithm is adopted to perform Step 426; if the element is 0, an assigned feeder group-oriented component allocation algorithm is adopted to perform Step 427;
initializing and assigning a component allocation algorithm selection link Seq01 link=1:1:2K, wherein elements in Seq01 link indicate indexes of the component allocation algorithms, Seq01 Bin is defined as a one-row and 2K-column array, first K columns in Seq01 Bin are 1, last K columns in Seq01 Bin is 0, and with each value in Seq01 link as an index, values corresponding to Seq01 Bin are obtained according to SeqCpAa; if Seq01 link(5) is 7, it indicates the seventh element in Seq01 Bin; if Seq01 Bin(7)=0, it indicates SeqCpAa(5)=0, that is, the assigned feeder group-oriented component allocation algorithm is adopted to perform Step 427; or, if Seq01 Bin(7)=1, it indicates SeqCpAa(5)=1, that is, the available feeder-oriented component allocation algorithm is adopted to perform Step 426;
initializing and assigning a head sequence SeqHd=1:1:H used for component allocation SeqHd=1:1:H, wherein if SeqHd(2)=2, it indicates that the sequence of head 2 during component allocation is 2;
initializing a component allocation information link CpAlink, wherein CpAlink is a one-row and (3*K+H)-column array formed by splicing SeqNZl, Seq01 link and SeqHd, value intervals are used for a distinguishing purpose, each value in SeqNZl is added by 30000, each value in Seq01 link is added by 20000, and each value in SeqHd is added by 10000, and then the three modified arrays are spliced to form CpAlink;
where, * is a multiplication sign; SeqNZl is a sub-cycle allocation sequence array, Seq01 link is the component allocation algorithm selection link, SeqHd is a head allocation array, Seq01 Bin is an algorithm selection binary array, and SeqCpAa is component allocation algorithm selection information; and
Step 32, initializing a pick-and-place path optimization sequence information link PAPlink, wherein the pick-and-place path optimization sequence information link is a one-row and K-column array, and PAPlink=1:1:K;
the heuristic adaptive information link HATSlink is a one-row and (4*K+H)-column array formed by splicing CpAlink and PAPlink.

6. The method for optimizing the placement process of surface mounters based on heuristic adaptive tabu search according to claim 5, wherein in Step 4, the component allocation information link CpAlink is decoded by the following steps:
executing the component allocation algorithm according to the component allocation information link decoding result to complete component allocation to obtain the component allocation result Cpg;
performing path optimization in all the pick-and-place cycles according to PAPlink, and updating the pick-and-place path optimization result;
calculating the corresponding total PCB assembly time TotalCost according to the nozzle assignment result, the component allocation result, and the pick-and-place path optimization result;
initializing the optimal total assembly time TotalCostbest=TotalCost, and then outputting the placement process optimal result;
a specific process comprises:
Step 41, decoding the component allocation information link CpAlink specifically as follows:
Step 411, using a numNZl-row and two-column array idxCyc to locate a current nozzle row number and pick-and-place cycle number under operation, wherein data in the first row of idxCyc indicate the number of the nozzle row under allocation in the nozzle assignment result NZg, data in the second row of idxCyc indicate the serial number of the first pick-and-place cycle to be allocated in the current nozzle row, and idxCyc(1,1)=1 indicates that component row 1 of the component allocation result corresponds to nozzle row 1; idxCyc(1,2)=floorNzCyc(1) indicates that component row 1 of the component allocation result corresponds to the current first pick-and-place cycle floorNzCyc(1); one component row indicates an array formed by numbers of the types of components picked up and placed by the heads in one sub-cycle;
Step 412, saving data information greater than 30000 in the component allocation information link CpAlink in the sub-cycle allocation sequence array SeqNZl, and subtracting 30000 from the data to obtain actual values;
Step 413, saving data information greater than 20000 in the component allocation information link CpAlink the component allocation algorithm selection link Seq01 link, and subtracting 20000 from the data to obtain actual values;
obtaining the component allocation algorithm selection information SeqCpAa=Seq01 Bin (Seq01 link) according to the component allocation algorithm selection link Seq01 link and the algorithm selection binary array Seq01 Bin;
Step 414, saving data information greater than 10000 in the component allocation information link CpAlink in the head allocation array SeqHd, and subtracting 10000 from the data to obtain actual values;
Step 42, performing the component allocation algorithm according to the component allocation information link decoding result to complete component allocation to obtain the component allocation result Cpg;
wherein, Cpg is an H-column two-dimensional array; elements in Cpg indicate the types of components picked and placed by the heads in the sub-cycles, and Cpg(4,3)=18 indicates that a component to be picked and placed by the third head in the fourth sub-cycle is of type 18;
Step 43, performing path optimization in all the pick-and-place cycles according to PAPlink, and updating the pick-and-place path optimization result specifically as follows:
wherein, PAPlink is the pick-and-place path optimization sequence information link;
Step 431, initializing a pick-and-place cycle count variable cntK=1, wherein the pick-and-place cycle count variable cntK is used for counting pick-and-place cycles that have completed path optimization;
Step 432, determining whether cntK>K, that is, determining whether path optimization of all the pick-and-place cycles have been completed; if so, determining that path optimization of all the cycles has been completed, and performing Step 44; if not, performing Step 433;
Step 433, obtaining a current cycle idxK=PAPlink(cntK) under optimization according to the pick-and-place path optimization sequence information link PAPlink;
Step 434, performing path optimization on the (idxK)^{th} pick-and-place cycle to obtain a pick-and-place path optimization result: a placement point allocation result PA(idxK,:), a placement sorting result PS(idxK,:), and a pickup slot allocation result FA(idxK,:) and a pickup sorting result FP(idxK,:) in each sub-cycle; and
Step 435, updating the count variable cntK=cntK+1, and returning to Step 432;
Step 44, calculating the total PCB assembly time TotalCost by:
obtaining a total movement distance total_dis of a head assembly according to the pick-and-place path optimization result, and calculating the total PCB assembly time TotalCost=total_dis/v based on the total movement distance total_dis and an average movement speed v of the head assembly; and
Step 45, initializing the total PCB assembly time TotalCost, and then performing Step 5.

7. The method for optimizing the placement process of surface mounters based on heuristic adaptive tabu search according to claim 6, wherein in Step 42, a specific process of performing component allocation algorithm according to the component allocation information link decoding result to complete component allocation to obtain the component allocation result Cpg comprises:
Step 421, initializing parameters related to component allocation specifically as follows:
Step 4211, obtaining a nozzle assignment result NZgs=NZg(:,SeqHd) after the heads are rearranged according to SeqHd;
wherein, SeqHd is a head sequence during component allocation, NZgs is the nozzle assignment result after the heads are rearranged, and NZg(:,SeqHd) is a nozzle assignment result sequentially read according to SeqHd;
Step 4212, sumSP=0, NZg0=NZgs, numKinCpl=numKinNZl;
wherein, the variable sumSP is the number of pickup operations reduced by means of simultaneous pickup;
the variable NZg0 is a nozzle assignment result obtained according to the sub-cycles for component allocation;
the variable numKinCpl is the number of pickup cycles in each component row;
the variable numKinNZl is the number of pick-and-place cycles in each nozzle row;
Step 4213, saving a temporary component allocation result under update in CPg0;
wherein, flagNZg0 is a flag array indicating that allocation of nozzle rows under update has been completed and is a one-row and numNZl-column array, and elements in flagNZg0 indicate whether component allocation of the nozzle rows has been completed;
numFdLim0 is a one-row and C-column array and indicates available feeders under update, and elements in the numFdLim0 indicate the numbers of available feeders corresponding to different types of components;
Fdg0 indicates feeder groups under update and is initialized into an empty array;
numFdg0 indicates the number of feeder groups under update and is initialized to 0;
numSPH0 indicates the number of different simultaneous pickup types under update and is initialized into a one-row and H-column array, the values of which are 0;
numPtinCp0 indicates the number of placement points corresponding to different types of components under update and is a one-row and C-column array, and elements in numPtinCp0store the number of placement points corresponding to non-allocated components;
the simultaneous pickup type refers to a possible case of simultaneous pickup of components on multiple feeders at one position when components on the feeders of the surface mounter are picked up, the number of the simultaneous pickup types corresponds to the number of the heads, there are totally H simultaneous pickup types SP1-SPH, and SP2 indicates that when a pickup action is performed at said position, two heads are able to simultaneously pick up components from two feeders;
wherein, numNZl is a total number of the nozzle rows, and CPg0 is the temporary component allocation result; and
Step 4214, numCPl0=numNZl, idxCyc0=idxCyc, sumSP0Max=−1, numNZl0K=0, cntK=0;
wherein, numCPl0 is the number of component rows under update;
idxCyc0 is an index array of cycles under update;
sumSP0Max is a maximum simultaneous pickup count variable and is initialized to −1, and there will be no simultaneous pickup after component allocation, so this variable is set to 0;
numNZl0K is used for saving nozzle rows that have completed component allocation;
cntK is used for counting pick-and-place cycles that have completed component allocation, is also used as a coded information index, and is initialized to 0;
numNZl is a total number of nozzle rows;
idxCyc is used for locating the current nozzle row number and pick-and-place cycle number under operation;
Step 422, determining whether the number numNZl0K of nozzle rows that have completed component allocation is less than the total number numNZl of nozzle rows; if so, performing Step 423; otherwise, returning to Step 43;
Step 423, saving the current temporary component allocation result in a temporary variable, and determining whether component allocation has been completed specifically as follows:
Step 4231, NZg0T=NZg0, numKinCplT=numKinCpl, CPgT1=CPg0, flagNZgT=flagNZg0, numFdLimT1=numFdLim0, FdgT1=Fdg0, numFdgT1=numFdg0, numSPHT1=numSPH0, numPtinCpT1=numPtinCp0, numCPlT1=numCPl0, idxCycT1=idxCyc0, cntK=cntK+1;
wherein, NZg0T is a temporary nozzle assignment result variable, and NZg0 is the nozzle assignment result obtained according to the sub-cycles for component allocation;
numKinCplT is a temporary variable of the number of pick-and-place cycles in each component row, and numKinCpl is the number of pick-and-place cycles in each component row;
CPgT1 saves the temporary component allocation result, and CPg0 is the temporary component allocation result under update;
flagNZgT is a flag array indicating that allocation of temporary nozzle rows has been completed, and flagNZg0 is a flag array indicating that allocation of nozzle rows under update has been completed;
numFdLimT1 is an array of the number of temporary available feeders, and numFdLim0 is an array of available feeders under update;
FdgT1 indicates temporary feeder groups, and Fdg0 indicates feeder groups under update;
numFdgT1 is the number of temporary feeder groups, and numFdg0 is the number of feeder groups under update;
numSPHT1 is the number of temporary simultaneous pickups, and numSPH0 is the number of simultaneous pickups under update;
numPtinCpT1 is the number of temporary placement points corresponding to different types of components, and numPtinCp0 is the number of placement points under update corresponding to different types of components;
numCPlT1 is the number of temporary component rows, and numCPl0 is the number of component rows under update;
idxCycT1 is an index array of temporary cycles, and idxCyc0 is an index array of cycles under update;
Step 4232, idxNZi=SeqNZl(cntK), idxNZl=idxCycT1 (idxNZi,1);
wherein, idxNZi indicates an index of a current nozzle row under component allocation;
idxNZl indicates a component row corresponding to the component allocation result;
SeqNZl(cntK) is data in the (cntK)^{th} row of the sub-cycle allocation sequence array;
idxCycT1 (idxNZi,1) is the number of the nozzle row corresponding to the (idxNZi)^{th} row of the index array of temporary cycles; and
Step 4233, if flagNZgT (idxNZi)=1, determining that component allocation has been performed on the component row, and returning to Step 422; if flagNZgT (idxNZi)=0, determining component allocation has not been performed on the component row, and performing Step 424;
Step 424, acquiring simultaneous pickup type data according to current nozzle row information specifically as follows:
Step 4241, NZl=NZg0T(idxNZi), wherein columns that are not equal to 0 in NZl are saved in an array idxNot0, the size of which is numNot0, NZl indicates the current nozzle row under component allocation, and numbers of nozzles to be allocated in the current nozzle row are saved in idxNot0;
Step 4242, cntNzT=0, wherein cntNzT is a count variable and is used for counting the types of nozzles in the current nozzle row;
when the types of nozzles in the current nozzle row are saved in libNzT, uplimflagSpT corresponds to a simultaneous pickup type search upper limit of the types of nozzles saved in libNzT, and flagSpT corresponds to a simultaneous pickup type search count array of the types of nozzles saved in libNzT;
libNzT, uplimflagSpT and flagSpT are updated and assigned in Step 4244 and are all one-dimensional arrays;
the types of nozzles in the current nozzle row are saved in libNzT;
Step 4243, if the current nozzle row NZl under component allocation is not empty, performing Step 4244; otherwise, performing Step 425;
Step 4244, if NZl(1)=1, cntNzT=cntNzT+1, libNzT.push(NZl(1)), multiplying numSpT_1 greater than 1 in numSpT(NZl(1)) by numSpT(NZl(1)), and saving the product in uplimflagSpT, that is, uplimflagSpT.push(numSpT_1*numSpT(NZl(1))), flagSpT.push(0); otherwise, directly performing Step 4245;
wherein, numSpT is a one-row and numNZl-column array and saves the number of simultaneous pickup types corresponding to N types of nozzles;
“.push( )” refers to the interpolation of a value at the end of an array;
cntNzT is a count variable for counting the types of nozzles in the current nozzle row, and libNzT.push(NZl(1)) indicates the interpolation of the current nozzle row under component allocation into libNzT, in which the types of nozzles in the current nozzle row are saved; numSpT(NZl(1)) is the number of simultaneous pickup types corresponding to the current nozzle row NZl(1) under component allocation, wherein numSpT indicates the number of simultaneous pickup types corresponding to different types of nozzles, numSpT_1 is the number greater than 1 in numSpT(NZl(1)), uplimflagSpT corresponds to the simultaneous pickup type search upper limit of the types of nozzle saved in libNzT, uplimflagSpT.push(numSpT_1*numSpT(NZl(1))) indicates the interpolation of a product of numSpT_1 and numSpT(NZl(1)) at the end of the array uplimflagSpT, and flagSpT.push(0) indicates the interpolation of 0 at the end of flagSpT, wherein flagSpT corresponds to the simultaneous pickup type search count array of the types of nozzles saved in libNzT; and
Step 4245, removing nozzles numbers, identical with NZl(1), from the current nozzle row NZl under component allocation, and returning to Step 4243;
Step 425, before component allocation is performed column by column on the current nozzle row, selecting a component allocation algorithm strategy specifically as follows:
Step 4251, flagOKT being a flag array indicating that component allocation of the heads has been completed and being a one-row and H-column array, and elements in flagOKT indicating whether component allocation of columns in the current nozzle row has been completed, if flagOKT is 1, determining that component allocation has not been completed; if flagOKT is 0, determining that component allocation has been completed, initializing flagOKT to an all-zero array, and under an idxNot0 index, setting flag OKT to 1, indicating “not allocated”;
wherein, numKinCol is an array of the number of to-be-allocated placement points corresponding to the heads and is a one-row and H-column array, in which the number of to-be-allocated placement points in the columns in the current nozzle row is saved, and numKinCol is initialized into an all −1 array;
Step 4252, setting all values in numFdLimT2=numFdLimT1, flagOK=flagOKT, FdgPrior1=SeqCpAa (cntK and numKinCol to numKinCplT (idxNZi);
wherein, numFdLimT2 indicates an array of second temporarily used available feeders;
flagOK indicates a flag array indicating that allocation of temporarily used heads has been completed;
FdgPrior1 indicates a feeder assignment flag; if FdgPrior1=1, it indicates that allocation is performed preferably according to available feeders; if FdgPrior1=0, it indicates that allocation is performed preferably according to feeder groups;
SeqCpAa (cntK) indicates the (cntK)^{th} element in the component allocation algorithm selection information link SeqCpAa, numKinCol indicates the array of the number of to-be-allocated placement points corresponding to the heads, numKinCplT (idxNZi) indicates the (idxNZi)^{th} element in the variable of the number of pick-and-place cycles in temporary component rows, and idxNZi is an index of the current nozzle row under component allocation;
Step 4253, if FdgPrior1=1, FdgPrior2=1; otherwise, FdgPrior2=0, wherein if FdgPrior2=1, it indicates that remaining heads cannot be allocated according to feeder groups;
if FdgPrior2=0, it indicates that remaining heads can be allocated according to feeder groups;
Step 4254, cntNot0=1, flagAvailable=0;
wherein, cntNot0 is a count variable and used for counting heads to be allocated; if flagAvailable is 0, it indicates that available feeders are not used during current allocation;
Step 4255, if cntNot0 is less than numNot0, performing step 4256; otherwise, performing Step 429;
Step 4256, idxH=idxNot0(cntNot0), cntNot0=cntNot0+1;
wherein, idxH is the head number corresponding to current component allocation;
idxNot0(cntNot0) indicates the (cntNot0)^{th} element in idxNot0, wherein idxNot0 indicates columns greater than 0 in the current nozzle row under component allocation;
Step 4257, if flagOK (idxH)=1, which indicates that the current head is not allocated, performing Step 4258; otherwise, performing Step 429;
wherein, flagOK (idxH) indicates the (idxH)^{th} element in the flag array indicating that allocation of the heads has been completed, and idxH indicates the number of the current head under component allocation;
Steps 4258, saving indexes corresponding to values, equal to NZg0T(idxNZi,idxH), in libNzT in the variable idxlibNzT;
wherein, NZg0T(idxNZi,idxH) refers to the value in the (idxNZi)^{th} row and the (idxH)^{th} column in NZg0T; if flagSpT(idxlibNzT)=1, idxCpTinNzT=SpT(NZg0T(idxNZi,idxH)); otherwise, idxCpTinNzT=idx_cp_type_nz_type(NZg0T(idxNZi,idxH));
idx_cp_type_nz_type is a one-row and N-column array and saves the types of components that can be picked and placed by different types of nozzles, and SpT is a one-row and N-column array and saves the simultaneous pickup types corresponding to different types of nozzles;
idxlibNzT indicates indexes of values, equal to NZg0T(idxNZi,idxH), in libNzT, flagSpT(idxlibNzT) indicates the (idxlibNzT)^{th} element in the simultaneous pickup type search count array of the types of nozzles saved in libNzT, idxCpTinNzT indicates the simultaneous pickup type corresponding to the current type of nozzles, SpT(NZg0T(idxNZi,idxH)) indicates the simultaneous pickup type corresponding to the nozzle type in the (idxNZi)^{th} row and (idxH)^{th} column in the temporary nozzle assignment result NZg0T, and idx_cp_type_nz_type(NZg0T(idxNZi,idxH)) indicates the type of components to be placed by the current type of nozzles NZg0T(idxNZi,idxH); and
Step 4295, if FdgPrior1=1 or FdgPrior2=1, performing Step 426 preferably according to available feeders; otherwise, performing Step 427 preferably according to feeder groups;
Step 426, performing component allocation preferably according to available feeder specifically as follows:
Step 4261, flagAvailable=1, flagFdLimTmp1=numFdLimT2, setting values equal to 0 in flagFdLimTmp1 to 1, and setting values equal to 1 in flagFdLimTmp1 to 0;
wherein if flagAvailable is 1, it indicates that available feeders are used during current allocation; if flagAvailable is 0, it indicates that available feeders are not used;
flagFdLimTmp1 indicates the number of transformed available feeders, and numFdLimT2 indicates the number of available feeders;
Step 4262, calculating a component selection function value numCptmpaccording to the number numPtinCpT1 of placement points to which components have not been allocated and the numbernumFdLimT2 of available feeders as follows:
$$numCptmp = numPtinCpT 1 ( idxCpTinNzT ) - flagFdLimTmp 1 ( idxCpTinNzT ) \times 1000$$
wherein, idxCpTinNzT indicates the simultaneous pickuptype corresponding to the current type of nozzles;
Step 4263, saving a maximum component selection function value numCptmp in a variable maxCpNum, and saving an index of the maximum value in a variable idxMaxCpNum;
wherein, maxCpNum indicates the maximum component selection function value, and idxMaxCpNum indicates the index of the maximum value;
Step 4264, if maxCpNum is equal to 0,numCptmp=numPtinCpT1 (idxCpTinNzT), saving the maximum component selection function value numCptmp in the variable maxCpNum, and saving an index of the maximum value in the variable idxMaxCpNum;
Step 4265, calculating the type of components to be allocated, idxCpT=idxCpTinNzT(idxMaxCpNum), CPgT1 (idxNZi,idxH)=idxCpT;
wherein, idxCpT indicates the type of selected components to be allocated, CPgT1 (idxNZi,idxH) indicates a temporary component allocation result of the (idxNZi)^{th} row and the (idxH)^{th} column, and idxCpTinNzT(idxMaxCpNum) indicates the (idxMaxCpNum)^{th} element of the simultaneous pickup type corresponding to the current type of nozzles; and
Step 4266, updating related information of the components and the heads:
Step 42661, updating the array numFdLimT2 of the second temporarily used available feeders;
numFdLimT2(pcb_cp_type_cp_lib_index(idxCpT))=numFdLimT2(pcb_cp_type_cp_lib_index(idxCpT))−1
wherein, pcb_cp_type_cp_lib_index(idxCpT) indicates the component number corresponding to the type idxCpT of selected components to be allocated;
Step 42662, updating the flag array flagOK indicating that allocation of temporarily used heads has been completed, flagOK (idxH)=0;
Step 42663, updating the array numKinCol of the number of to-be-allocated placement points corresponding to the heads;
numKinCol(idxH)=min(maxCpNum,numKinCol(idxH));
wherein, min(maxCpNum,numKinCol(idxH)) refers to calculation of the maximum component selection function value numCptmp and a minimum value in the (idxH)^{th} column of the array of the number of to-be-allocated placement points corresponding to the heads; and
Step 42664, updating the number of temporary placement points corresponding to different types of components;
numPtinCpT1(idxCpT)=numPtinCpT1(idxCpT)−numKinCol(idxH)
wherein, numPtinCpT1 indicates the number of temporary placement points corresponding to different types of components, and numKinCol indicates the array of the number of to-be-allocated placement points corresponding to the heads;
Step 427, performing allocation preferably according to feeder groups specifically as follows:
Step 4271, idxFdgHd=1, optnumSp=0, cntFdgT=1;
wherein, idxFdgHd indicates whether allocation can be performed according to feeder groups; if idxFdgHd=1, it indicates that allocation cannot be performed according to feeder groups; if idxFdgHd=0, it indicates that allocation can be performed according to feeder groups;
the variable optnumSp is used for recording an optimal number of simultaneous pickups in the current allocation process;
cntFdgT is an ergodic count of a current feeder group;
Step 4272, if the count cntFdgTof the current feeder group is less than the number of temporary feeder groups, idxsizeFdg=1, and performing Step 4273; otherwise, performing Step 428;
wherein, idxsizeFdg indicates a count variable for NzFdg counting;
the number of components in the current feeder groups is sizeFdg, sizeFdg is equal to FdgT1(cntFdgT), the type of nozzles corresponding to the type of components in the current feeder group is saved in a variable NzFdg, which is a one-row and sizeFdg-column array, and each value in NzFdg is initialized to 0;
idxsizeFdg is a count variable for NzFdg assignment, and FdgT1(cntFdgT) indicates the (cntFdgT)^{th} elements in the temporary feeder group;
Step 4273, assigning the type NzFdg of nozzles corresponding to the type of components in the current feeder group specifically as follows:
Step 42731, if the count variable idxsizeFdg for NzFdg assignment is less than the number sizeFdg of components in the current feeder group, performing Step 42732; otherwise, performing Step 42734;
Step 42732, if FdgT1(cntFdgT) (idxsizeFdg) which indicates the (idxsizeFdg)^{th} item in FdgT1(cntFdgT) is greater than 0, NzFdg (cntFdgT)=pcb_cp_type_nz_lib_index(FdgT1(cntFdgT) (idxsizeFdg)), and performing Step 42733;
wherein, NzFdg (cntFdgT) indicates the type of the (cntFdgT)^{th} nozzle corresponding to the type of components in the current feeder group, and pcb_cp_type_nz_lib_index indicates nozzle numbers corresponding to the type of components;
Step 42733, updating the count variable for NzFdg assignment idxsizeFdg=idxsizeFdg+1, and returning to Step 42731;
Step 42734, if FdgT1(cntFdgT) (idxsizeFdg) which indicates the (idxsizeFdg)^{th} item in FdgT1(cntFdgT) is greater than 0, NzFdg (cntFdgT)=pcb_cp_type_nz_lib_index(FdgT1(cntFdgT) (idxsizeFdg)), and performing Step 42735; and
Step 42735, updating the count variable for NzFdg assignment idxsizeFdg=idxsizeFdg+1, and returning to Step 42731; and
Step 4274, looping and determining whether simultaneous pickup is available when the components in the feeder group correspond to the heads, and performing component allocation, specifically:
Step 42741, initializing the count variable i=sizeFdg−1;
wherein, sizeFdg indicates the number of components in the current feeder group;
Step 42742, if i is greater than 1−H, performing Step 42743; otherwise, performing Step 42748;
Step 42743, flagOK2=flagOK, numKinCol1=numKinCol, numPtinCp2=numPtinCpT, CPg2=CPgT1, cntSp=0;
wherein, flagOK2 is used for saving the flag array indicating that allocation of temporarily used heads has been completed, and flagOK indicates the flag array indicating
that allocation of temporarily used heads has been completed;
numKinCol1 is used for saving the array of the number of to-be-allocated placement points corresponding to the heads, and numKinCol is the number of to-be-allocated placement points corresponding to the heads;
numPtinCp2 is used for saving the temporary number of placement points corresponding to different types of components, and numPtinCpT1 indicates the temporary number of placement points corresponding to different types of components;
CPg2 is used for saving the temporary component allocation result, and CPgT1 indicates the temporary component allocation result;
cntSp is used for counting simultaneous pickups;
Step 42744, minj=max((i+1),1), maxj=min(H+i, sizeFdg), wherein the minimum value is minj, the maximum value is maxj, max(a,b) is used for selecting a greater value from 1 and b, and min(a,b) is used for selecting a smaller value from a and b; H indicates the total number of heads of the surface mounter; sizeFdg indicates the number of components in the current feeder group; i is the count variable in Step 42471 and indicates the i^{th} element in the feeder group, and j is an ergodic count variable of type of components in the feeder group used in Step 42745 and indicates the j^{th} element in the feeder group;
Step 42745, looping through the types of components in the feeder group for component allocation specifically as follows:
1, using j=minj as an ergodic count variable of the type of components in the feeder group;
2, if j is less than maxj, performing 3; otherwise, performing Step 42746;
3, idxH=j−I, idxCpT=FdgT1(cntFdgT)(j);
wherein, idxH indicates the number of heads under current component allocation, idxCpT indicates the type of components selected for component allocation, and FdgT1(cntFdgT)(j) indicates the j^{th} element in the current temporary feeder group;
4, if flagOK2(idxH) is not equal to 0, idxCpT is not equal to 0, NzFdg(j) is equal to NZg0T(idxNZi,idxH) and numPtinCp2(idxCpT) is not equal to 0, performing the following operations:
updating the simultaneous pickup count variable cntSp, cntSp=cntSp+1;
updating the temporary component allocation result CPg2, CPg2(idxNZi,idxH)=idxCpT;
updating and saving the temporary flag array flagOK2 indicating that allocation of heads has been completed, flagOK2(idxH)=0;
updating the array numKinCol1 of the temporary number to-be-allocated placement points corresponding to heads, numKinCol1 (idxH)=min(numPtinCp2(idxCpT), numKinCol1 (idxH));
updating the temporary number numPtinCp2 of to-be-allocated placement points corresponding to heads, numPtinCp2(idxCpT)=numPtinCp2(idxCpT)-numKinCol1 (idxH);
wherein, NzFdg(j) indicates the j^{th} type of nozzles corresponding to the type of components in the current feeder group, and CPg2(idxNZi,idxH) indicates the (idxH)^{th} element in the temporary component allocation result in the (idxNZi)^{th} row;
5, j=j+1, returning to 2;
Step 42746, if the simultaneous pickup count cntSp is greater than the current optimal number optnumSp of simultaneous pickups, updating as follows:
updating the variable idxFdgHd indicating whether allocation can be performed according to feeder groups, idxFdgHd=0;
updating the optimal number optnumSp of simultaneous pickups in the current allocation process, CPg3-CPg2;
flagOK3=flagOK2, numKinCol2-numKinCol1, numPtinCp3=numPtinCp2;
wherein, CPg3 is another temporary component allocation result;
flagOK3 is another temporary array indicating whether allocation of heads has been completed, and flagOK2 is the saved temporary flag array indicating that allocation of heads has been completed;
numKinCol2 is used for saving another temporary array of the number of to-be-allocated placement points corresponding to heads;
numPtinCp3 is used for saving another number of placement points corresponding to different types of components;
Step 42747, i=i−1, returning to Step 42747; and
Step 42748, updating the ergodic count variable of the current feeder group, cntFdgT=cntFdgT+1, and returning to Step 4272;
Step 428, if idxFdgHd is greater than 0, performing the following operations:
updating a flag FdgPrior2 indicating whether remaining heads can be allocated according to feeder groups, FdgPrior2=1;
updating the count variable cntNot0, cntNot0=cntNot0=1;
otherwise, performing the following operations:
updating the temporary component allocation result CPgT1, CPgT1=CPg3;
updating the temporary flag array flagOK indicating that allocation of heads has been completed, flagOK=flagOK3;
updating the array numKinCol of the number of to-be-allocated placement points corresponding to heads, numKinCol=numKinCol2;
updating the temporary number numPtinCpT1 of placement points corresponding to different types of components, numPtinCpT1=numPtinCp3;
updating the count variablecntNot0, cntNot0=1;
returning to Step 4255;
Step 429, saving indexes, not equal to 0, in the array numKinCol(idxNot0) of the number of to-be-allocated placement points corresponding to heads in an array idxCPgSubcyNot0, the size of which is numCPlSubcyNot0;
if numCPlSubcyNot0 is equal to numNot0, which indicates that the number of placement points corresponding to some heads is 0, indicating that the allocation is invalid, performing Step 4201; if numCPlSubcyNot0 is not equal to numNot0, returning to Step 422 to perform the next round of component allocation;
wherein, idxCPgSubcyNot0 indicates non-zero indexes of the array of the number of to-be-allocated placement points corresponding to the heads, numCPlSubcyNot0 indicates the number of non-zero indexes of the array of the number of to-be-allocated placement points corresponding to the heads, and numNot0 indicates the number of non-zero columns in the current nozzle row under component allocation; and
Step 420, further performing component allocation by means of the component allocation method, saving a component allocation result in CPg, saving a nozzle assignment result obtained according to the sub-cycles for component allocation in NZg0, updating the feeder group Fdg0 according to the nozzle assignment result, and saving the number of simultaneous pickups for different types of components in numSPH; returning to Step 422 to perform the next round of component allocation.

8. the method for optimizing the placement process of surface mounters based on heuristic adaptive tabu search according to claim 7, wherein initializing tabu search parameters in Step 5 comprises: initializing the neighbor operation ActionList, and determining the tabu length nAction and the unimproved tabu search upper limit NI, specifically:
Step 51, determining a neighbor operation list ActionList according to a variable numSeq which is equal to the sum of the length of the component allocation information link CpAlink and the total number K of pick-and-place cycles, wherein ActionList is a 2*numSeq²−numSeq-row and three-column array, a first column of which represents an operator identifier and a second column and a third column are increasing sequences;
wherein, * indicates a multiplication sign;
first
$$\frac{numSeq * ( numSeq - 1 )}{2}$$
rows are commuting operator, the operator identifier in the first column is 1, the second column is an increasing sequence from 1 to numSeq−1, and the third column is an increasing sequence from 2 to numSeq;
rows from the
$${( \frac{numSeq * ( numSeq - 1 )}{2} )}^{th}$$
row to the (numSeq*(numSeq−1))^{th} row are reversal operators, the operator identifier in the first column is 2, the second column is an increasing from 1 to numSeq-1, and the third column is an increasing sequence from 2 to numSeq;
rows from the (numSeq*(numSeq−1))^{th} row to the (2*numSeq²−numSeq)^{th} row are interpolation operators, the operator identifier in the first column is 3, the second column is an increasing from 1 to numSeq-1, and the third column is an increasing sequence from 2 to numSeq;
ActionList(2) is to acquire the second row of the neighbor operation list, and ActionList(2)(1) is to acquire a value in the second row and the first column of the neighbor operation list;
Step 52, denoting the number of times of being disabled of neighbor operations in the neighbor operation list as TC, and denoting the number of times of being disabled of updating is as TL;
TL=ceil(1.5\sqrt{numSeq}), denoting the length of ActionList as nAction, and initializing TL into an nAction-row and one-column array;
wherein, ceil( ) indicates an operation of rounding up to an integer of a result when a floating number is calculated; and
Step 53, saving an optimal tabu neighbor operation list selection index in iActionbestTabu, initializing iActionbestTabu=0, initializing an unimproved search counting variable ni=0, and initializing the unimproved tabu search upper limit to NI.

9. The method for optimizing the placement process of surface mounters based on heuristic adaptive tabu search according to claim 8, wherein in Step 6, a specific process of determining whether the current number of times of unimproved tabu searches is less than the unimproved tabu search upper limit; if so, performing Step 7; otherwise, performing Step 9 comprises:
Step 61, determining whether the unimproved search counting variable ni is less than or equal to NI; if so, performing Step 62; otherwise, performing Step 9;
NI=TL;
wherein, NI indicates the unimproved tabu search upper limit, and TL indicates the number of times of being disabled of updating;
Step 62, initializing the optimal assembly time TotalCostbestTabu to be infinite inf, and initializing a count variable it in this round to 1; and
Step 63, if it is less than TL, performing Step 71; otherwise, performing Step 84.

10. The method for optimizing the placement process of surface mounters based on heuristic adaptive tabu search according to claim 9, wherein in Step 7, a specific process of performing a neighbor search operation on the heuristic adaptive information link to obtain the current heuristic adaptive information link, invoking the heuristic adaptive information link decoding algorithm to decode the current heuristic adaptive information link to obtain the corresponding placement process optimization result as the candidate solution, and performing Step 8 comprises:
Step 71, setting a tabu flag TCflag=1, and setting a neighbor operation list selection index iAction=ceil(nAction*rand( ), wherein rand( ) indicates the generation of a floating number from 0 to 1;
Step 72, newHSlink=DoAction(HATSlink,ActionList(iAction));
wherein, newHSlink is a new heuristic adaptive information link;
HATSlink indicates the heuristic adaptive information link;
DoAction( ) is an operator identifier corresponding to ActionList(iAction)(1), and corresponding commuting, reversal and interpolation operations are performed on two indexes ActionList(iAction)(2) and ActionList(iAction)(3) of HATSlink to obtain the new heuristic adaptive information link;
ActionList(iAction)(1) indicates a first element in the (iAction)^{th} row of the tabu list, ActionList(iAction)(2) indicates a second element in the (iAction)^{th} row of the tabu list, and ActionList(iAction)(3) indicates a third element in the (iAction)^{th} row of the tabu list;
Step 73, if TC(iAction) is not equal to 0, TCflag=0; otherwise, not changing the value of the tabu flag TCflag;
TC(iAction) indicates the number of times of being disabled of the neighbor operation on the (iAction)^{th} row of the tabu list;
Step 74, because the heuristic adaptive information link HATSlink is a one-row and (4*K+H)-column array formed by splicing the component allocation information link CpAlink and the pick-and-place path information link PAPlink, updating the heuristic adaptive information link according to the new heuristic adaptive information link HATSlink=newHSlink, then splitting HATSlink, using first (3*K+H) columns of HATSlink to update CpAlink, and using last K columns to update PAPlink;
Step 75, performing Step 41 and Step 42 to decode the component allocation information link CpAlink, and performing component allocation according to a decoding result; and
Step 76, performing Step 43, Step 44 and Step 45 to decode the updated pick-and-place path information link PAPlink, obtaining a pick-and-place path according to the decoding result, and then obtaining a candidate solution according to the nozzle assignment result, the component allocation result and the pick-and-place path optimization result;
wherein, the total PCB assembly time TotalCost is calculated as follows:
the total movement distance total_dis of the head assembly is obtained according to the pick-and-place path optimization result, and the total PCB assembly time TotalCost=total_dis/vis calculated based on total movement distance total_dis and the average movement speed v of the head assembly;
in Step 8, a specific process of updating a current solution according to the candidate solution and a tabu list, updating the tabu list, and returning to Step 6 comprises:
Step 81, if the total PCB assembly time TotalCost obtained by performing Step 67 is less than the optimal total assembly time TotalCostbest, updating the current solution:
updating the optimal total assembly time TotalCostbest=TotalCost;
updating the optimal heuristic adaptive information link HATSlinkbest=newHSlink;
wherein, newHSlink is a new heuristic adaptive information link;
updating an optimal neighbor operation list selection index iActionbest-iAction;
wherein iAction is the neighbor operation list selection index;
otherwise, not updating the current solution;
Step 82, if TCflag=1 and TotalCost is less than TotalCostbestTabu, updating the tabu list:
updating the optimal total assembly time in the tabu list TotalCostbestTabu=TotalCost;
updating the optimal heuristic adaptive information link HATSlinkbestTabu=newHSlink;
updating an optimal tabu neighbor operation list selection index iActionbestTabu=iAction;
otherwise, not updating the tabu list;
Step 83, it=it+1, returning to Step 63;
Step 84, ni=ni+1;
Step 85, updating the tabu list and the heuristic information link specifically as follows:
Step 851, if TotalCostbest is less than TotalCost, performing Step 825; otherwise, performing Step 855;
Step 852, updating the heuristic information link and the total PCB assembly time HATSlink=HATSlinkbest, TotalCost=TotalCostbest;
Step 853, updating the tabu list specifically as follows:
Step 8531, defining a loop variable i=1;
Step 8532, if i is less than nAction, performing Step 8533; otherwise, returning to Step 854;
Step 8533, if i is equal to iActionbest, TC(i)=TL; otherwise, TC(i)=max (TC(i)−1,0);
wherein, TC(i) indicates the number of times of being disabled of the neighbor operation on the i^{th} row in the neighbor operation list; and
Step 8644, i=i+1, returning to Step 8532;
Step 854, ni=0;
Step 855, updating the heuristic adaptive information link HATSlink=HATSlinkbestTabu; and
Step 856, updating the tabu list specifically as follows:
Step 8561, defining a loop variable i=1;
Step 8562, if i is less than nAction, performing Step 8563; otherwise, performing Step 86;
Step 8563, if i is equal to iActionbest, TC(i)=TL; otherwise, TC(i)=max (TC(i)−1,0); and
Step 8564, i=i+1, returning to Step 8562; and
Step 86, returning to Step 6.
